(19) United States
(12) Patent Application Publication
(10) Pub. No.: US 2024/0046169 A1
(43) Pub. Date: Feb. 8, 2024

(54) ONLINE DESIGN PROJECT STACKING/MATCHING PLATFORM

(71) Applicant: Dorothy Lynn Myers, Washington, DC (US)

(72) Inventor: Dorothy Lynn Myers, Washington, DC (US)

(21) Appl. No.: 18/229,266

(22) Filed: Aug. 2, 2023

Related U.S. Application Data
(60) Provisional application No. 63/370,355, filed on Aug. 3, 2022.

(51) Int. Cl. G06Q 10/0631

(52) U.S. Cl. CPC G06Q 10/063112

(57) ABSTRACT

In accordance with certain embodiments, a design stacking and matching system includes an application operable on a computing device accessed by a user, the application configured to present a user interface for entry of user information including one or more of location, style, scope of work or budget, and a matching manager implemented on one or more processors and coupled to the application over a data network. The matching manager matches between the user and one or more professionals based on the user information entered by the user and the professional.

This application claims the benefit of U.S. provisional application number, 63/370,355, filed on Aug. 3, 2022 and incorporated in its entirety herein by reference.

### BACKGROUND

### Technical Field

The technical field relates to a computer-implemented online platform enabling matching of interior designers and remote users for design projects over a network.

### Related Art

Websites have been used to match homeowners with designers. Conventional websites however have been limited, biased or ineffective in meeting most residential interior design needs. One type of conventional website provides results to a homeowner client based on a “pay to play” approach. In other words, the professional pays a fee to “purchase” certain zip codes and their name/business is then included in the homeowner search results based on their zip code. Additionally, the higher amount that the professional pays the more times their business name would appear in the search results or the higher on the list of results to the homeowner. This can bias search results according to an amount paid by the designer rather than the needs of the homeowner for a particular design project. Currently, this is the primary self-guided approach used by prior art platforms that focus on the residential interior design client. Also, online matching sites based on location alone falls short of providing a satisfactory experience both to the homeowner and the designer in many cases as it omits other significant design criteria. None of the currently known sites incorporate the client's design aesthetic, take in consideration the scope of the project to be done or the budget i.e., project investment into the design equation or provide guidance on the importance/significance of using a certified trade professional.

### BRIEF SUMMARY OF THE DISCLOSURE

In accordance with certain embodiments, an online design project matching platform includes a matching manager configured to communicate with a remote application. The application is operable on a computing device accessed by a user. The application is configured to present a user interface for entry of user information including one or more of location, style, project scope or budget/investment. The matching manager is implemented on one or more processors and coupled to the remote application over a data network. The matching manager is configured to match the user with one or more providers or designers (such as up to three at any one time) based on the user information entered by the user for a design project.

In another aspect, a method of matching one or more clients to one or more service providers includes presenting a user interface for an entry of user information including one or more of location, style, scope of work or budget, each being a layer of a stack; filtering the data in the stack to provide a match search result with one or more professionals; and matching one of the clients to one or more service providers based on the user information entered by the user.

The system described, which includes a method of matching clients to service providers, may significantly increase computer performance in several ways:
Efficient User Interface: The user interface presented by the system allows clients to easily enter their information, including location, style preferences, scope of work, and budget. This streamlined interface ensures quick data input, reducing the time and resources needed for user interactions.
Data Filtering and Stack Optimization: The data filtering process involves narrowing down the search results based on the user's input. By filtering the data in the stack, the system reduces the search space, allowing for faster and more precise matching between clients and service providers.
Parallel Processing: The method can leverage parallel processing techniques to filter and match multiple clients with service providers simultaneously. This optimization effectively utilizes multiple processing units, improving overall system throughput and response times.
Data Indexing and Searching: To efficiently match clients with service providers, the system can use data indexing techniques to quickly access and retrieve relevant information from the stack. This speeds up the search process, particularly when dealing with large datasets.
Machine Learning and Recommendation Systems: The system can incorporate machine learning algorithms or recommendation systems to enhance the matching process. By analyzing past successful matches and user feedback, the system can make better predictions and improve the quality of the matches.
Caching and Data Storage Optimization: The system can implement caching mechanisms to store frequently accessed data temporarily. By reducing the need for repeated data retrieval, caching enhances the speed of subsequent matching operations.
Scalability and Load Balancing: The system's architecture can be designed for scalability and load balancing, allowing it to handle a growing number of clients and service providers. This design ensures that the system maintains optimal performance even during peak usage periods.
Real-time Matching: The system can perform real-time matching, providing instant results to clients and minimizing wait times. Real-time matching is especially crucial for users seeking prompt service provider matches.
User Profiling and Data Preprocessing: The system can preprocess user information and create user profiles to streamline future matching processes. By understanding user preferences and historical data, the system can quickly identify potential matches for each client.
Fast Response Time: The combination of efficient data handling, filtering, and matching processes ensures that the system delivers fast response times to clients. This quick turnaround enhances user satisfaction and encourages repeat usage of the matching service.

The described method of matching clients to service providers thus may offer various computer performance enhancements. By optimizing data handling, leveraging parallel processing, using data indexing, and incorporating machine learning, the system provides efficient and accurate matches between clients and service providers. These performance improvements lead to a better user experience and make the system capable of handling a large number of users with minimal delays.

Further aspects, features, and advantages of the invention, as well as the structure and operation of the various embodiments of the invention are described in detail below with reference to accompanying drawings.

### BRIEF DESCRIPTION OF THE DRAWINGS

FIG. 1 is schematic diagram of an on-line design project system in accordance with an embodiment of the present invention.

FIG. 2 is a diagram showing an online design project matching platform in further detail according to an embodiment.

FIG. 3A is a flowchart diagram of a routine for initializing an online design project matching platform according to an embodiment while FIGS. 3B-3G illustrate the stacking operation.

FIGS. 4A and 4B are a flowchart diagram of a routine for matching clients and designers with an online design project matching platform according to an embodiment.

FIGS. 5A-5C, 6-15, 16A, 16B, and 17-28 show example user interfaces displayed for users seeking to submit their projects as clients to be matched with potential designers.

FIG. 29 shows a summary of example client information provided to designers.

FIGS. 30-40 show example user interfaces displayed for users looking to join the service as designers and connect with clients.

The accompanying drawings, which are incorporated into and constitute a part of this specification, illustrate one or more examples of aspects of the present disclosure and, together with the description of examples herein, serve to explain the principles and implementations of the embodiments. The drawings should not be viewed as exclusive configurations. The subject matter disclosed is capable of considerable modifications, alterations, combinations, and equivalents in form and function, as will occur to those skilled in the art and having the benefit of this disclosure.

### DESCRIPTION OF EXAMPLE EMBODIMENTS

The present disclosure relates generally to an online marketplace resource serving both the architectural and design (A&D) community i.e., interior designers/decorators, architects, landscape architects, kitchen and bath designers, builders and design-builders and homeowners helping to find each other to create beautiful spaces together, for example in a specific local area, such as the Washington, DC, Maryland, and Virginia area, regionally or nationally. In embodiments, a computer-implemented online platform, methods and systems enable matching of interior designers and remote users for design projects over a network based on geographic location, multi-level project scope of work, design style/aesthetic and project budget.

The inventor recognized there is a need for an online design project matching platform that uses four primary factors critical to making a successful initial client designer partnership: location, project scope, project investment (i.e., the budget) and the design style (or design aesthetic that the homeowner is seeking, and that the designer has expertise in). The creation of this utility patent and other design search criteria will facilitate a-match of a homeowner client user with certified interior designers for a design project. In one feature, the additional design search criteria includes location, project scope, design style and budget/investment. Using the combination of location, design style, project scope and budget/investment) enables the online design project matching platform to meet the needs of a design project for a broad range of users in an unbiased and effective way over a network. This is a particularly effective and a more efficient way to match different types of remote user and designers across different design projects having a variety of design styles and budgets, such as, design projects involving residential designs.

In further embodiments. online design project matching may be used for commercial designs, may include a bidding process (RFP—requests for proposals) for both residential and commercial projects, residential and commercial builders, landscape architects, kitchen & bath designers, interior architects and architects (architectural planning and design build).

In a further feature, initial design search criteria can be prioritized based on a scope of work. For example, individual spaces within a residential design may be ranked.

In one embodiment, an online design platform supports an application that allows a client to enter their name and password and a name of their project through a user-interface element on a remote device. The client is then asked for the location via zip code and asked if they want the search to be local, regional or national (and eventually internationally). In one example, a search may be limited to local only i.e., within a 50-mile radius, to simplify search results listings.

Using the application, the client user moves to a project scope section. First, they identify what type of home the project is located in—single family home (SFH), condo, coop, townhome (other types of homes will be identified later). Next, the client user identifies if they want a designer/decorator or a designer/renovator (i.e., for a home design/decorate project or a home design/renovate project) or a combination of both decoration and renovation within the same project scope in the home i.e., the guest rooms will need decoration and the bathroom will require renovation. The definitions or explanation of those terms as well as other important terms at this stage may be provided to the client user through a user-interface element to help them to determine which one to choose. In further examples, options may be provided in the application for a full or partial design-build/renovation, RFP bidding process for residential and commercial projects, etc.

The client will then be asked through the application if there were a timeframe that they would like to start and/or end the project. They can also skip this question if they are open to a start date. In one embodiment, this information may not factor into the matching process but will be reported out to the designers.

On the scope stack, the process will continue to further configure a scope of work. The client user through user-interface elements provided by the application will identify the scope of work by selecting the rooms to be renovated. They can identify the number of spaces that will be design/decorated or design/renovated. Additionally, if they selected that they wanted both design/decorated and design renovated, the algorithm will provide the option of choosing which design direction the client user wants to go in with each space identified.

As to the style stack, under the design aesthetic, the user can determine the overall style direction and once they meet with the designer(s), they can provide more detail and if the design aesthetic will change with each space. Other examples may include the option of having the user to specify the design aesthetic for each space.

Example embodiments are described herein in the context of an online design matching system and method. The following description is illustrative only and is not intended to be in any way limiting. Other embodiments will readily suggest themselves to those of ordinary skill in the art having the benefit of this disclosure. Reference will be made in detail to implementations of the example embodiments as illustrated in the accompanying drawings. The same reference indicators will be used to the extent possible throughout the drawings and the following description to refer to the same or like items.

### Terminology

The term “location” as used herein refers to a physical location of the project site identified by location information such as a postal code (e.g., a zip code), latitude/longitude (lat./long.), a mailing address, a residence address (such as, one or more of a street address, unit number, zip code, city, state, and/or country that uniquely identifies a residence or unit within a residence) or other types of information specifying a location or a combination thereof

The term “space” as used herein refers to a living room, kitchen, kitchenette, dining room, den, family room, bedroom, bathroom, hallway, foyer, closet, sunroom, library, home office, in-law suite, garage, basement, mudroom, bar area, game room, meditation room, theatre room, laundry room, gym, or any other interior space of a residence. A sleeping space can be a category of spaces where a person can sleep, such as, bedroom, in-law suite, children's room or guest bedroom. A space as used herein may also be a space in a commercial or business site.

The term “residence” as used herein refers to a single-family home, townhouse, row house, apartment unit, cooperative/condominium unit, or other unit that houses one or more people.

The terms “style” or “design style” are used interchangeably herein and each refers to a design style or aesthetic. A design style as used herein refers to a look defined by one or more well established and defined style categories. The look can be further refined by adjectives for different style categories. Adjectives may be also associated with a style category to define a particular design style or look. For example, a style category may include, but is not limited to one of the following styles: traditional, modern, contemporary, eclectic, boho, grand millennial, post-modern, bohemian, farmhouse, classic, etc. Adjectives may further describe the feel of a design style that a client is looking for or that describes a designer's approach to the space, such as, fun, colorful, adventurous, modern, sophisticated, clean, eclectic, classic, timeless, bold, serene, or peaceful. These categories and terms can be used separately or combined to define the user's style. Used together the terms can be defined as the user's design aesthetic.

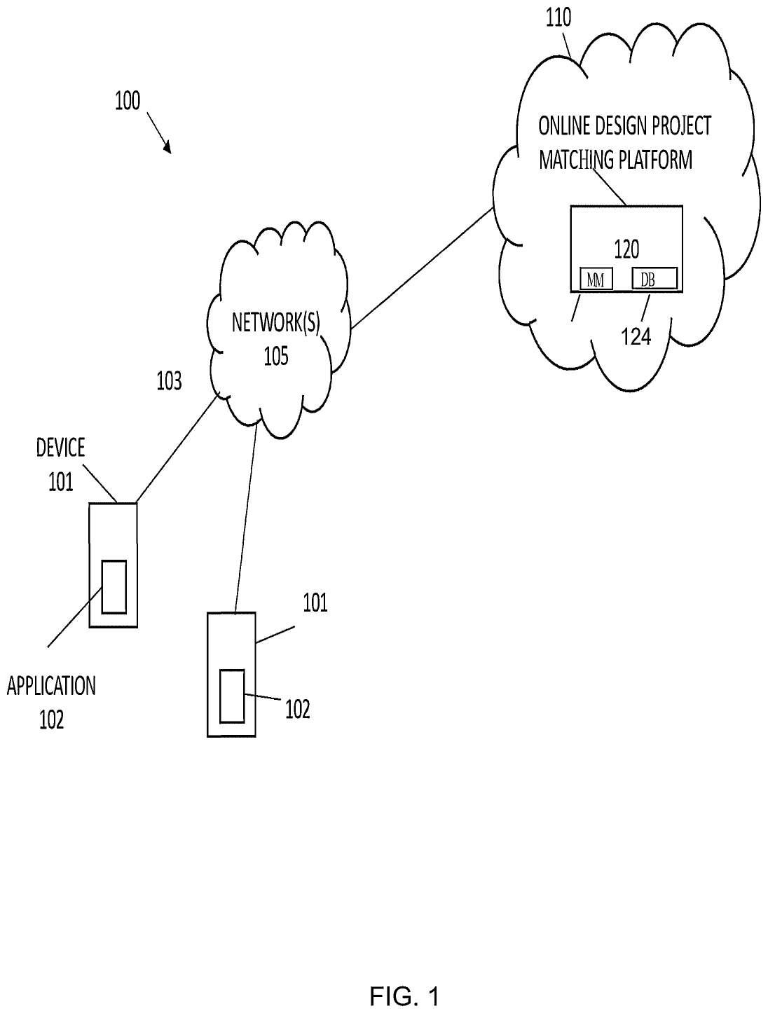

Disclosed herein and described with reference to FIG. 1 is a unique on-line interior designer/decorator and homeowner client matching system 100 for example in the form of an online platform for example operated as an app running on a laptop or desktop computer, tablet or mobile device. Specifically, in certain embodiments the system 100 includes one or more client computing devices 101 on which an application 102 is run. In certain embodiments, the application may be accessed through a web browser of the device, for example as an add-on. The client devices 101 are connected via communication links 103 and over one or more data networks 105 to an online design project matching platform 120. The online design project matching platform can include a matching manager 122 and one or more databases 124. The matching manager 122 can be an application that is executable on one or more computing devices, such as servers, that are disposed at one or more network-linked locations. The matching manager 122 operates to match the two marketplaces (designers and clients) based on factors such as the client's budget/investment, location, scope of work and personal style for their home (or commercial concern). In certain embodiments it includes software and/or hardware modules that execute algorithms to achieve the best match between a client and a design professional, and present image options and results to the client for ranking and selection as described below. The databases 124 can store files that are for example each associated with a design professional, including the professional's contact information, credentials and qualifications, references, sample portfolios, minimum project investment requirement, and any other information that may be relevant to determine whether they would be a good match for a particular client's project as described herein.

The application running on client device 101 is configured to display a user interface for entry of the information described below. The display and user interface can be customized depending on whether the user is a client/homeowner looking for a designer/professional, or a designer looking to join the service and connect with clients.

In embodiments, the term application (such as application 102 ) refers to an application, web application, browser, or browser extension. For example, application 102 may be configured as an application installed on computing device 101 or may be a web application operated through a browser or browser extension on computing device 101. Application 102 may be implemented in software, firmware, hardware, or any combination thereof on a computing device 101. Computing device 101 may run application 102 and communicate over data networks 105 including over the World Wide Web using web protocols or other communication protocols.

Online design project matching platform 120, including matching manager 122, may be implemented in software, firmware, hardware, or any combination thereof and may be implemented on one or more computing devices at the same or different locations. Online design project matching platform 120 may also be configured as a computer-implemented cloud-based platform supporting web-based services, data storage, user registration, application services, communications, or management functions. A computer-implemented platform such as a cloud-based, Software as a Service (Saas) and/or Infrastructure as a Service (Iaas) platform may be used in platform 120. Applications 102 may be also configured on computing devices 101 at one or more locations and may be coupled through network interfaces over one or more data networks 105, such as a local area network, medium area network or wide area network, such as the Internet, to the cloud-based platform. Web servers and World Wide Web protocols may be provided as part of the platform. Firewalls or other security mechanisms may be included.

One goal of system 100 is to match residential and/or commercial clients with qualified professionals in the fields of architecture, interior design/decorating, interior design/renovating, kitchen and bath design, builder, interior architect, design builder and landscape architecture. In certain embodiments, system 100 can focus on connecting homeowners to interior designers/decorators or interior designers/renovators. While the interior designers/decorators or renovators may be able to provide services in the aforementioned areas, their primary designation will be as residential interior designers/decorators and that is the category that homeowners will search for. The user client will select what type of home is the project located i.e., single family home (SFH), condo, cooperative, or townhome. In other words, the homeowner will be able to select a scope of work for kitchen and/or bathroom in their single family home as a singular space(s), and will be able to designate whether they want to proceed to hire a design professional for design/decorate or design/renovate services.

In another embodiment, whole spaces may be configured, such as, for a whole home/condo-coop and an interior designer/decorator and/or a design builder as a whole home/condo project scope. If the homeowner selects interior design services for the whole home/condo-coop, they would be advised that contractors may still be necessary to carry out work at this level i.e., carpentry, plumbing, electrical, etc. without the use of a builder but the primary purpose of this scope would be interior design/decoration i.e., 75% or more of the job is interior design/decoration.

In other embodiments, selections can be made in other categories, such as architecture, landscape architecture, kitchen and bath designer, builder, interior architecture, and design-builder. While for clarity and brevity the disclosure is described in terms of home/residential applications, it will be anticipated that non-home applications, such as commercial applications, are also contemplated.

In a further feature, system 100 can further pair a client and a designer not only based on their location but uniquely match them based on the client user's (e.g., homeowner's) budget/investment, the scope of work and personal style, or on other selected criteria.

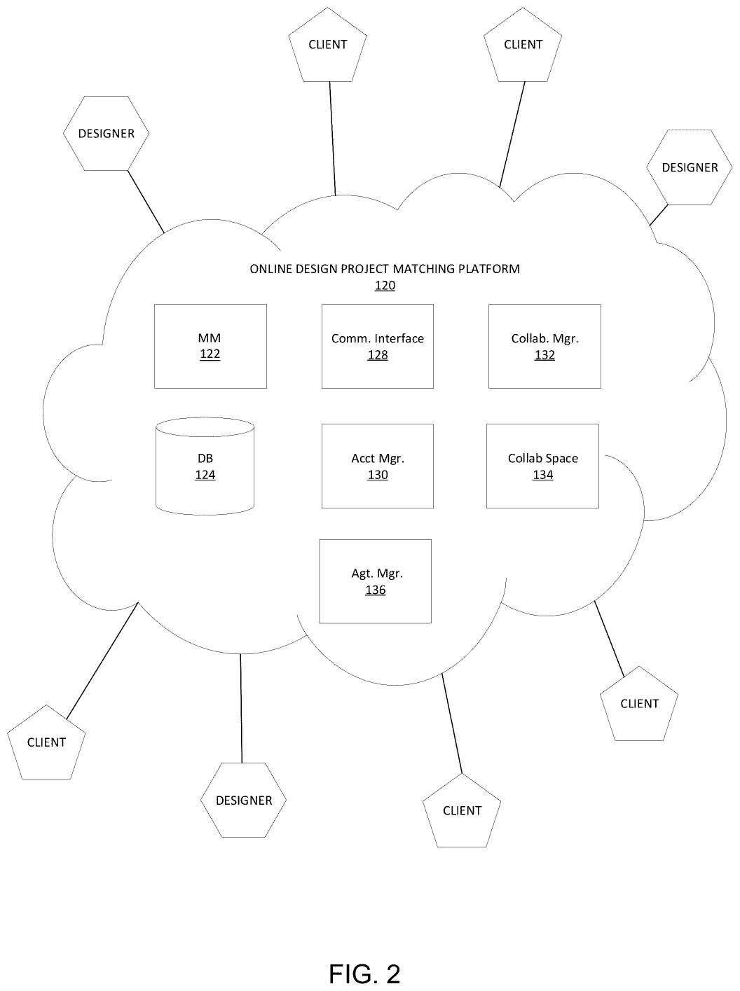

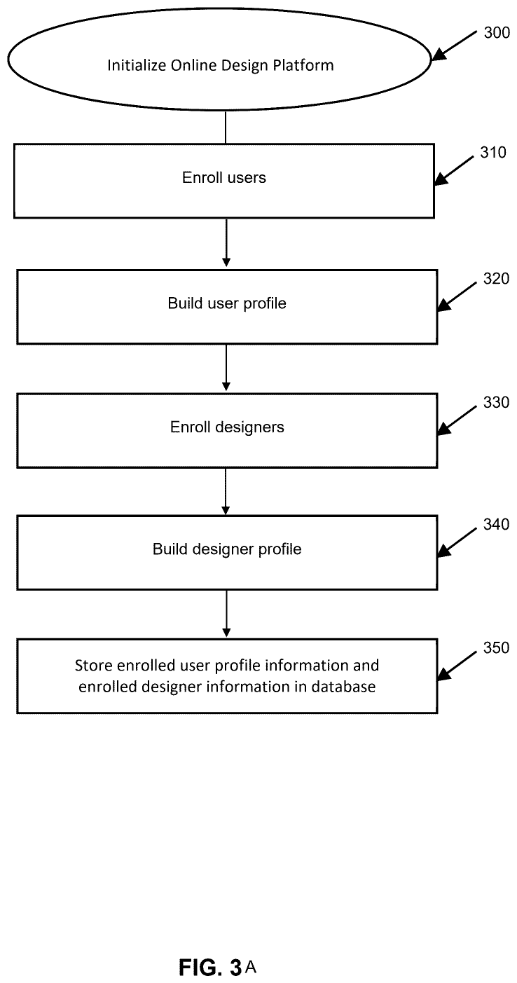

FIG. 2 showing in more detail components of platform 120. These include matching manager 122, the primary function of which is to match clients and designers with one another based on criteria that these two parties (or markets) input to the system and that are stored in databases 124 through which the matching manager algorithmically sifts to identify the best matches. A programmable matching algorithm 126 can be utilized by matching manager 122 for this purpose. Each of the components of FIG. 2 may be implemented in hardware or software or a combination of both and their functionality may be distributed over multiple devices or modules.

A communication interface 128 is used to facilitate communications between platform 120 and clients and designers and operates for example to manage user (client and designer) experience and interaction with the platform 120, for example through a website or user interface controlled by the platform. An account manager 130 manages system security and the accounts of the clients and designers. A collaboration manager 132 controls collaboration between select designers who may be working together on a project for a client and manages a collaboration workspace 134 in which these designers can present ideas and communicate and collaborate with one another in developing a joint project for a client. An agreement manager 136 automatically generates agreement between parties, for example and client and designer(s), laying out the terms of the services provided as detailed below.

### Operation

The operation of system 100 including online design project matching platform 120 and applications 102 to perform design project matching is described in further detail below.

### Initialization

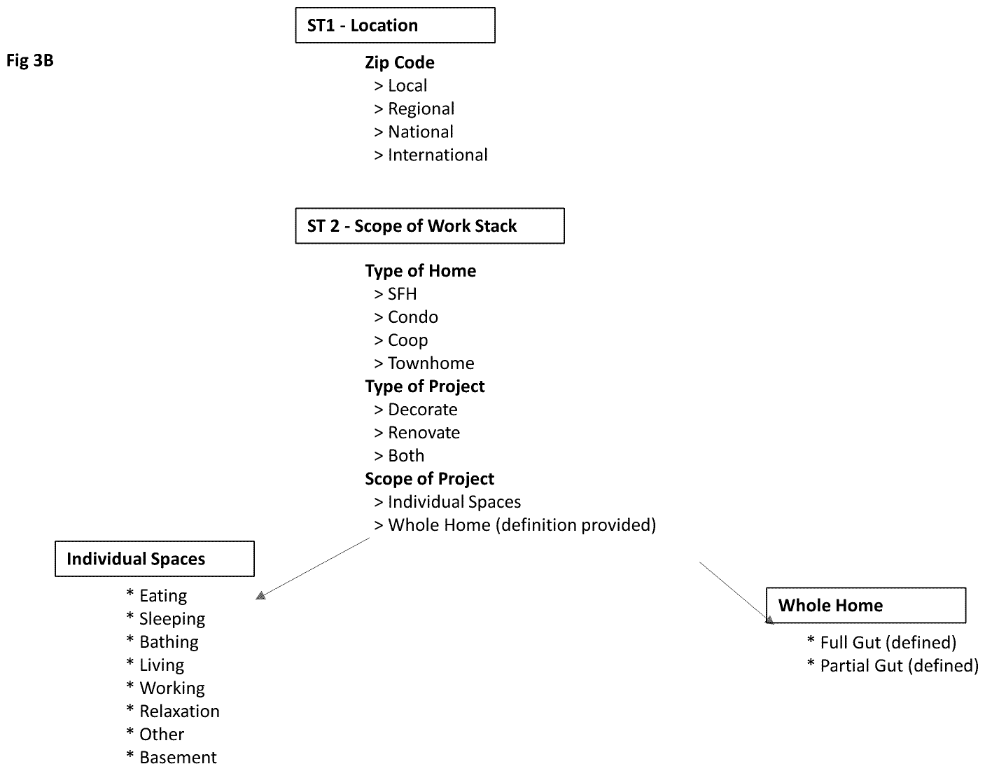

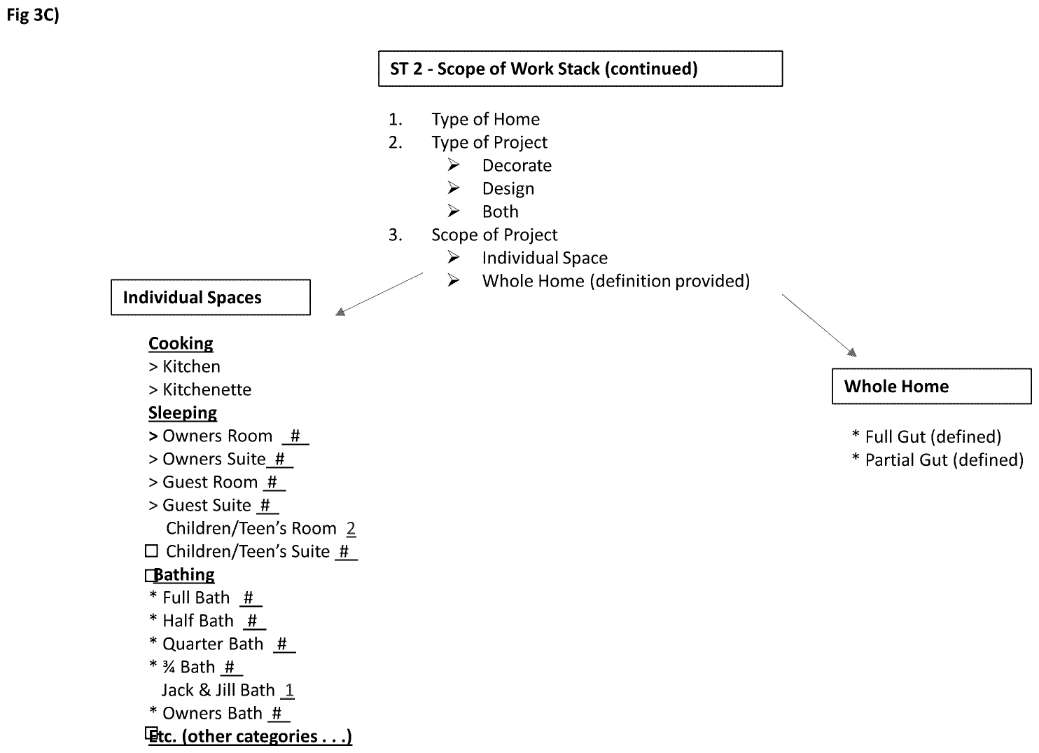

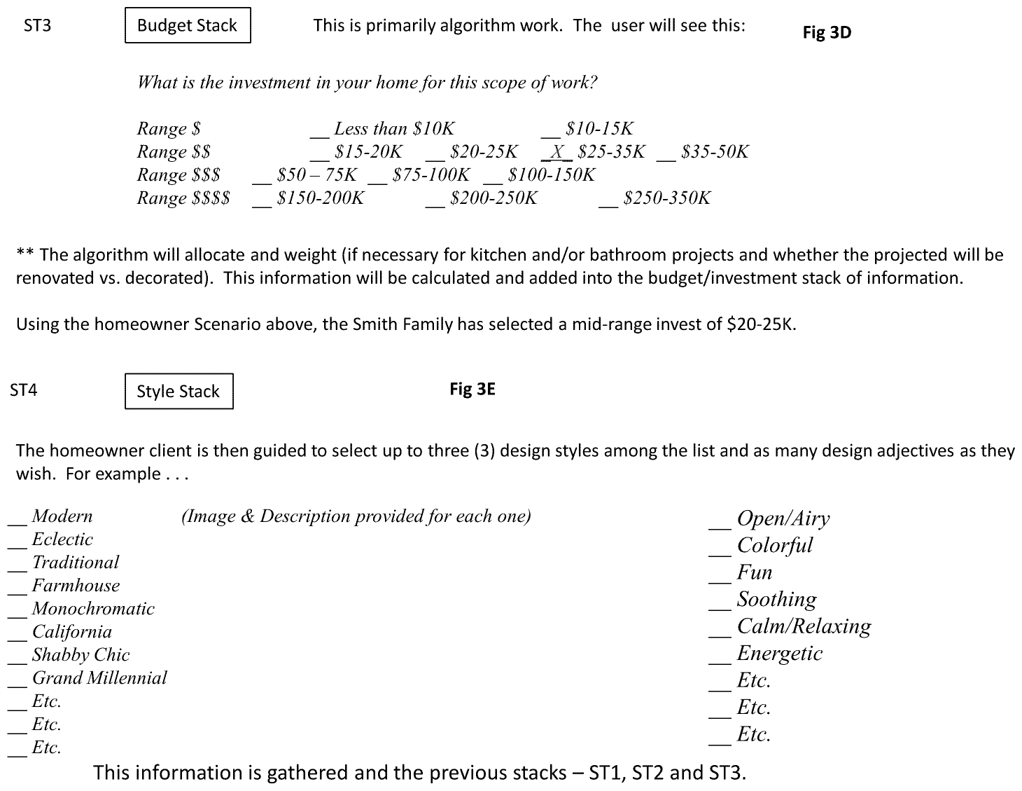

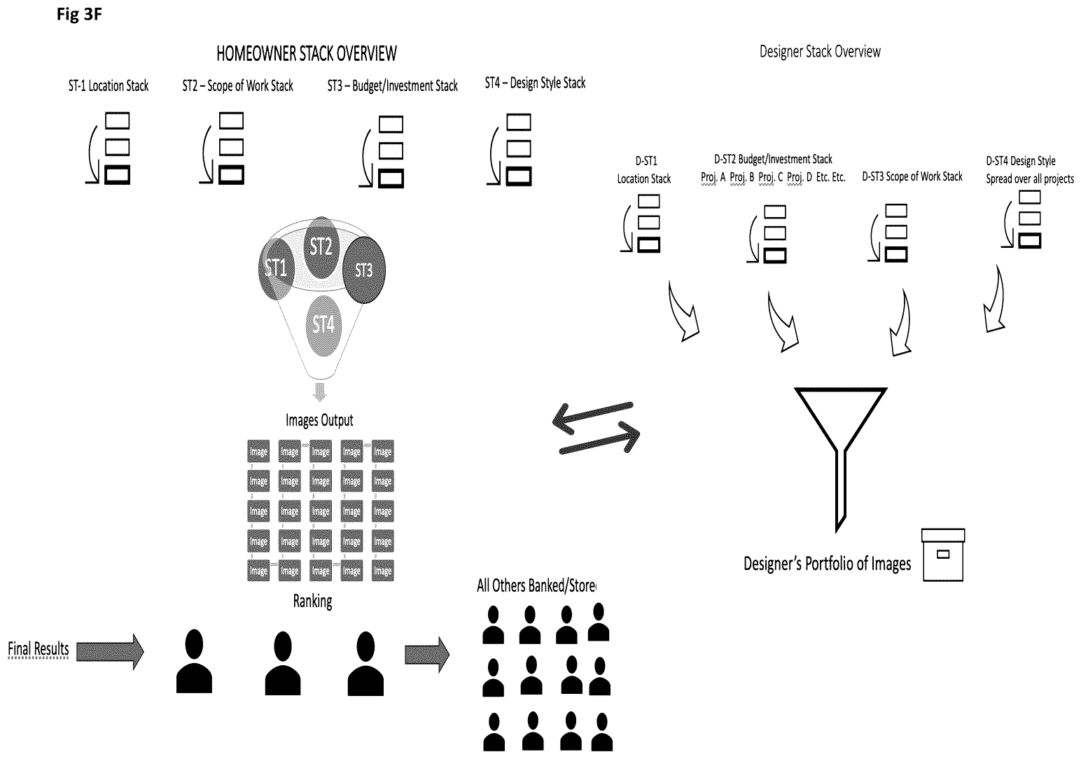

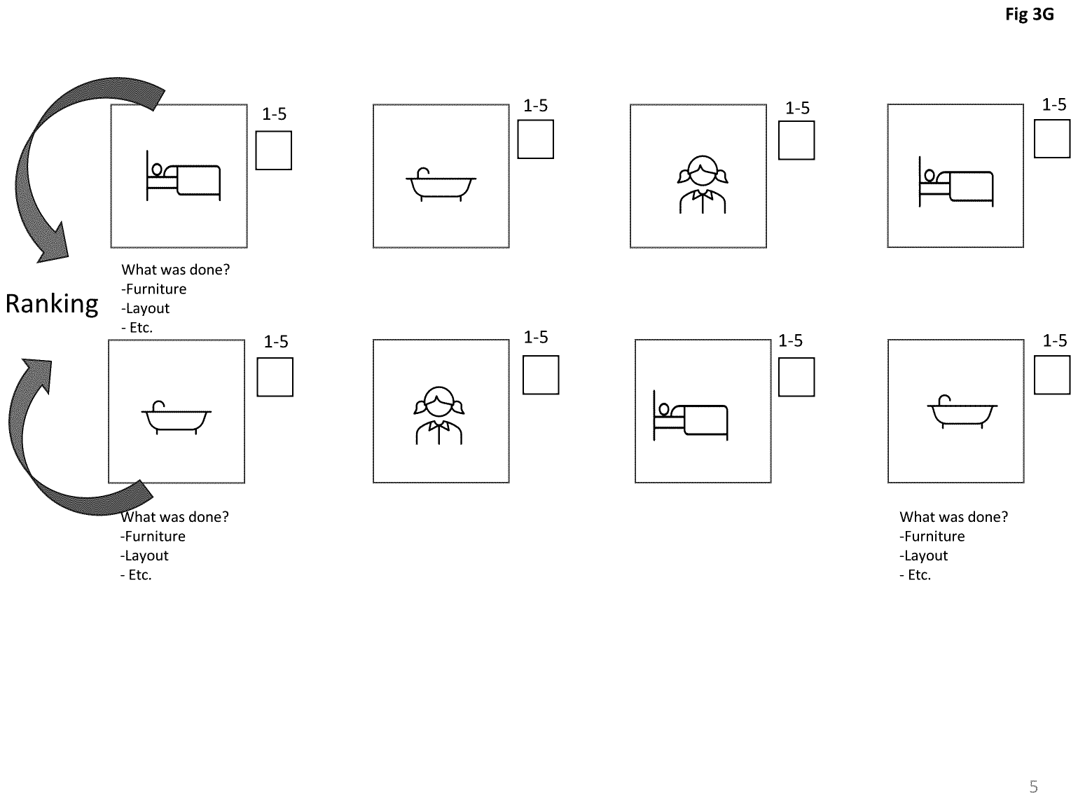

FIG. 3A is a flowchart diagram of a routine 300 for initializing an online design project matching platform 120 according to an embodiment (steps 310-350). In step 310, one or more users are enrolled into the online design project matching platform 120. For example, a user can download and open an application 102 on a device 101. Application 102 and platform 120 then communicate with one another to provide output from platform 120 to application 102 and to provide input from a user of application 102 to platform 120. Application 102 may provide a series of user-interface elements, such as, one or more graphical user displays, that enable a user to view information and enter user inputs. For example, to enroll a user in step 310, application 102 may output one or more display views that enable a user to create a new account or access an existing account on platform 120.

FIGS. 3B-3G illustrate the stacking operation of user information for a first criteria set from a first provider including one or more of location, style, scope of work or budget, and the application stacks data from the entry from a second criteria set for a second provider in the order of location, style, scope of work or budget to be filtered to provide a match search result. These operations will be discussed with respect to a homeowner scenario of a Smith family. The Smith family wants to update the bedrooms of their two children as they mature into teenagers. They would like to use as much existing future as possible and update the bedroom and renovate the Jack and Jill bathroom connecting to the two rooms to something more functional and timeless—a look that will not become outdated as the children continue to grow and leave for college.

The algorithm will allocate and weight (if necessary for kitchen and/or bathroom projects and whether the project will be renovated vs. decorated). This information will be calculated and added into the budget/investment stack of information. Using the homeowner Scenario above, the Smith Family has selected a mid-range investment of $20-25K.

In this example, the homeowner client is then guided to select up to three (3) design styles among the list and as many design adjectives as they wish.

### Homeowner Stack Overview

Viewing FIGS. 3B-3G together, the client receives images based on ST1, ST2 and ST3 and ST4 (using the initial scenario, the images shown would be of children's rooms and Jack and Jill bathrooms that fit within the investment range for renovation and decoration for each space and that meet the style parameters set by the user.

The homeowner would rank each image from 1-5 or another inventor created scale. Once this ranking is completed, the algorithm compiles the “score” and presents the registered user with the top three (3) matches of interior designers along with a list of questions that may help them to get the conversation started with their designer, FAQs, all contact information including social media, etc.

The designer will also get “pinged” that they have been matched with a homeowner/potential client. They will receive a client summary page of basic and pertinent information. The register designer may also create an auto response through this platform outlining the next steps for contact.

### Designer User Stacking Scenario

A design professional is a licensed and registered interior designer has been in business for over 20 years. She has done work primarily locally but is open to regional work, but not work that is national or international because she wants to stay close to home.

She has a mid level firm, employing 3-4 administrative and design staff and her business has approximately $1M-1.5M in annual revenue. Her firm has done some commercial work in the past but her clients are primarily residential with the average project in the $50-75K range. She is looking to grow her business and increase her revenue while still keeping her marketing and business developments costs low.

### Style Stack

The designer can add style information to each image as he/she uploads their project folders or they can choose to select their overall style both in description and adjective which will be applied to all images uploaded. The style stack D-ST4 may be combined with D-ST2 and D-ST3. The culmination of information/data from all of the stacks, ST1, ST2, ST3 and ST4 will be sent to the database to find images that cross all four designer user data stacks D-ST1, D-ST2, D-ST3 and D-ST4.

### Cross Discipline Stacks

In later iterations, each of the professional disciplines i.e., interior design, architect, design builders, landscape architects and kitchen &amp; bath designers will be able to use the platform to submit RFPs for both residential or commercial work and separate stack will be created for each cross discipline. For example, if an interior design is looking for an architect or vice versa, the designer stack seeking an architect is displayed is FIG. 3G. The designer or architect will still use the Location Stack, the Budget Stack and the Scope Stack but they will be informed by and tailored to each discipline.

In implementations, a mobile app, web app, or PC software will compile information within each subset of the four primary criteria—location, scope, style and investment (budget). After the information from each subset has been compiled and filtered and it is then be stacked on top of the next criteria set in the order of location, scope, investment and style in order to achieve the optimal match for both markets. The order that these criteria will be stacked and the specific algorithm may change as the app expands to different A&D categories. In other words, the criteria for interior designers may differ from the criteria for architects (especially considering that architects and builders will, in many cases receive RFPs as part of their matching). This will continue for each criteria set and then filtered to provide a limited match search result for the client. This stack/match method not only creates an efficiency for the user and provide a cost savings/efficiency for business development and marketing for the A&D professional, but also increases the likelihood of finding profitable clients for the design and a signification and time savings for the homeowner and efficiencies for both markets.

An example of the stack for each of the criteria is below:

Location Stack—The simplest form is by zip code to filter the property location within a certain mile radius, the criteria will expand (as the database increases) to include regional, national and international professionals. The benefit to the homeowner is that they will be able to expand their search for professionals based on their budget and desired design aesthetic. The professional will be able to expand their reach to clients without having to increase their marketing budget on expensive national magazine ads and rely on getting published or spending additional manhours on social media.

Scope of Work Stack—After the homeowner identifies the type of home of the project, i.e., single family home, condo, coop, townhome, etc., they select whether they are interested in interior decoration; interior renovation, or both and whether this is for individual spaces or the entire home. The individual spaces sub-stack will have types of spaces— i.e., sleeping, eating, cooking, bathing, etc., etc., with sub-categories under each one. The selection of renovation as well as the “eating” i.e., kitchen and “bathing” i.e., bathroom spaces will be weighted higher in the investment/budget stack of the algorithm in relation to the other identified spaces selected or if the entire project is identified as decoration. An example of this will be provided in the investment/budget stack. An additional layer to this stack is the ranking/prioritization of the spaces. The results of this entire stack selection and ranking will be configured in relation to/on top of the Investment/Budget Stack. The design professional will similarly be asked to provide images of project spaces that they have completed and to include the budget ranges required for a client to achieve that look—or that a past client (of 3 years or less) spent to achieve that look. The design professional will also indicate if the project was decorated, renovated or had a combination of both and if so, the professional will indicate the percentages. This information is not weighted at all on the professional side, significant calculation is done on the client side of the investment/budget and correlating that to the scope of work. This is significant since the correlation between scope of work and budget typically does not happen until after the client and designer have met. This allows both designer and client to understand what is achievable within a specific investment range from the beginning. Again, saving significant time and frustration and bringing clients to the designer that are able to work with the resources and vendors that represent their brand.

Investment/Budget Stack—This is the most significant (and least obvious) part of the algorithm. The logic for this stack can become quite nuanced but I will provide a simple example for the purposes of this application. Once the homeowner client has ranked the priority of their project scope of work, they will be guided to the investment/budget section. If, for example, a homeowner identifies the decoration of two sleeping spaces—a girl's bedroom and a boy's bedroom and the renovation of an existing bathing space—a Jack & Jill bathroom and they have identified an investment range of $20,000-25,000 (the app will instruct the homeowner that this range includes a 25% project contingency which is the industry average of 25-30%). If all factors were equal and all three spaces are being decorated, the budget of $20,000 would be split accordingly with each space being allocated between $6,500 and $8,000 per space (approximately). In this case, (after the selection of the style stack), the homeowner would be shown spaces (children's bedrooms and bathrooms) that were achieved for $8,000 or less. However, using the example above, the renovation of the bathroom will need to be weighted at a higher rate of approximately 45-50% of the budget meaning that the two bedrooms would be decorated for between $5,000 and $6,000 approximately and bathrooms for between $10,000 and $12,500. Therefore, the homeowner would be shown spaces (children's bedrooms and bathrooms) that were achieved in that budget range. This method addresses the various combinations that can be developed under the scope stack and layering on the location stack. This stack will be adjusted when the app expands to include the other A&D categories of architecture, design builders, kitchen & bath designers and landscape architects since the investment nuances will vary. Additionally, if the client indicates a scope of work of an entire home, and identifies if it is a decoration, renovation or a combination of both (a definition will be provided for the minimum required to be defined as a “whole home” project), the investment/budget question will be informed from the design professional side. The professional will need to indicate if they have completed whole home design, whole home renovation or whole home with a combination of the two. Only those professionals that are certified interior designers will be included in the algorithm for whole home renovation and their images for the spaces indicated or their whole home portfolio will be in presented to the homeowner during the final selection and ranking process.

Style Stack—After the client has indicated the information for each stack i.e., property location, the scope of work and their investment, the homeowner will be guided through the style stack and be provided with options to indicate their particular style among a list of defined and well-known styles i.e., modern, traditional, farmhouse, eclectic, etc. and use that in combination with style adjectives i.e., warm, colorful, peaceful, etc. This is important since most designers no longer limit their designs to only a few defined/established design styles. Many expand their aesthetic to moods, feelings, colors, etc. This will allow both the homeowner and the designer to find the aesthetic that resonates with both of them facilitating an easy and early connection on this critical factor. This combination of both styles and adjectives is again typically addressed only after the homeowner and designer have met. Addressing this detail at the beginning, creates significant time savings for both the homeowner and the designer and enhancing the communication and increasing the likelihood that the homeowner and designer will be “on the same page” from the beginning.

Once all of these critical factors and their separate, layered/stacked, unique algorithms are completed and filtered, only then will the matching take place.

The design matching system improves computer performance in several ways:

Efficient User Interface: The user interface presented by the application allows users to input their information, including location, style, scope of work, and budget. This streamlined interface ensures that users can quickly and easily provide their preferences and requirements, reducing the time and effort needed to enter data.

Data Network and Remote Access: The system's cloud-based architecture allows users to access the application from various computing devices connected to the data network. This enables users to access the matching system remotely, eliminating the need for local installations and improving accessibility and scalability.

Matching Manager and Processor: The matching manager, implemented on one or more processors, efficiently handles the matching process. It takes the user's input and searches for suitable professionals based on the provided information. The use of processors allows for parallel processing, enhancing the speed and efficiency of matching operations.

Filtering and Stacking [symbol] : The matching manager filters available designer information based on the user's initial search criteria, location, scope of work, desired design style, and budget. This filtering process narrows down the options via a stacking process, focusing on relevant A&D professionals [symbol] , and improves the accuracy and speed of the matching.

Scoring and Ranking Information: The system calculates a score for each designer based on the user's ranking of designs and search criteria. This ranking information helps identify the top designers that closely align with the user's preferences, significantly reducing the time required for manual screening and selection.

Electronic Introductions: The system electronically introduces the user to the top-ranked designers. This automated process speeds up the communication and collaboration between clients and designers, improving the overall efficiency of the matching process.

Interactive Configuration: The users, both homeowners and design professionals, can interactively configure the scope of work for interior design projects and provide input on design style and budget. This interactive approach ensures that the user's requirements are accurately captured and facilitates faster decision-making.

Sample Images and Selection: By presenting multiple sample images to the user that fit the user's specific criteria, the system streamlines the process of selecting designs, which can be extremely time-consuming otherwise. This interactive sample selection enhances the user experience and speeds up the matching process.

Cloud-Based Scalability: The system's cloud-based architecture ensures scalability, allowing it to handle a large number of users, designers, and design projects simultaneously. Cloud-based solutions can leverage distributed computing resources, enabling parallel processing to further improve performance.

In summary, the design matching system's architecture, cloud-based approach, use of a matching manager, interactive user interface, and automated processes contribute to improved computer performance by reducing response times, optimizing resource utilization, and enhancing overall efficiency in matching designers with clients for A&D, interior design and architectural design projects. The above design stacking and matching system offers several features and advantages that enhance the user experience and improve the efficiency of matching designers with clients for architectural design projects:

User-Friendly Interface: The system provides a user-friendly interface that allows clients to input their design preferences easily. Users can enter information such as location, style, scope of work, and budget through a simple and intuitive user interface.

Efficient Matching Process: The system's matching manager efficiently processes the user's input and filters available designer information based on the user's criteria. This reduces the time and effort required to find suitable designers for each client's specific project.

Customizable Scope of Work: Clients can interactively configure the scope of work for their interior design projects. They can specify the spaces to be designed, such as living rooms, kitchens, bedrooms, or bathrooms, allowing for personalized and tailored design solutions.

Design Style Selection: The system enables clients to provide input on their desired design style. This ensures that designers who match the client's preferred style are prioritized in the matching process, leading to a higher likelihood of successful and satisfying design outcomes.

Budget Consideration: Clients can specify their budget for the interior design project. The system considers this budget during the matching process, ensuring that only those designers who align with the client's budget constraints are considered for the project.

Sample Images and Selection: By presenting multiple sample images, the system offers clients a visual representation of design possibilities. Clients can select from these sample images, which helps them convey their preferences and saves time in the design exploration phase.

Automated Designer Introductions: The system automatically introduces the client to the top-ranked designers. This automated process facilitates prompt communication and collaboration, streamlining the initiation of the design project.

Efficient Review and Ranking: The system allows clients to review and rank a set of designs. The ranking information is then used to calculate scores for each designer. This streamlined process ensures that designers who receive high rankings are matched with suitable clients, enhancing the overall efficiency of the system.

Scalability and Accessibility: The system's cloud-based architecture ensures scalability, enabling it to handle a large number of clients and designers simultaneously. The cloud-based approach also allows users to access the system from any computing device with internet connectivity, providing enhanced accessibility.

Time-Saving and Resource Optimization: The automated processes, efficient filtering, and quick matching help save time for both clients and designers. Additionally, the system optimizes computing resources through parallel processing, enhancing the overall performance.

Enhanced Design Recommendations: By considering the client's preferences and project scope, the system can provide designers with valuable insights, resulting in more relevant and personalized design recommendations.

The design matching system's features and advantages enhance the overall user experience, expedite the designer-client matching process, and ensure that clients receive tailored and satisfactory architectural design solutions. The system's cloud-based scalability and resource optimization further contribute to its efficiency and effectiveness in matching clients with the most suitable designers.

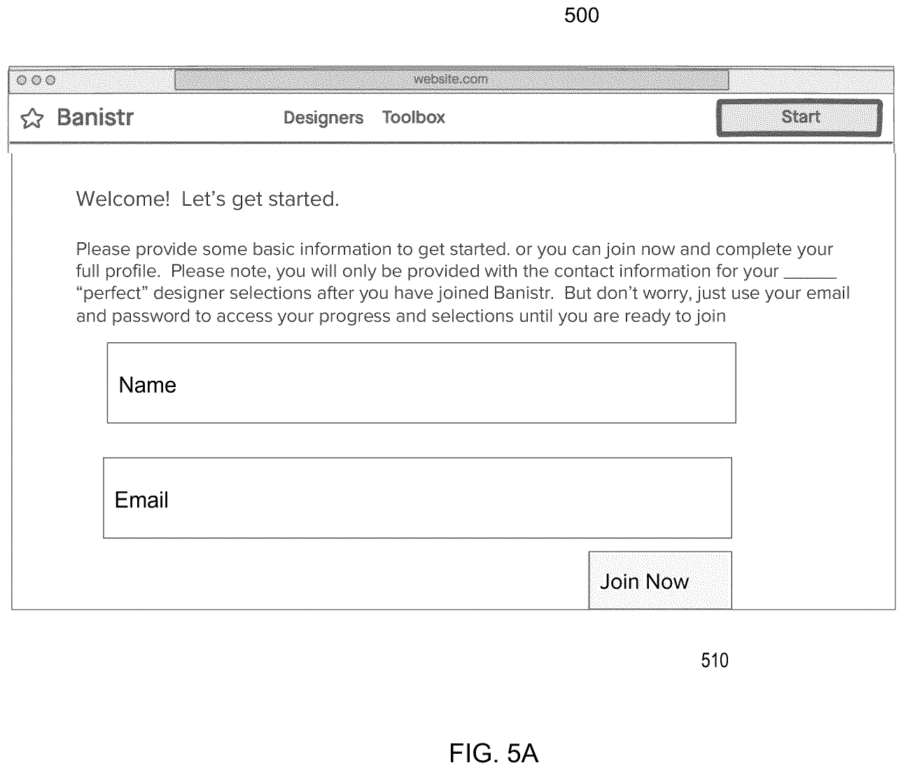

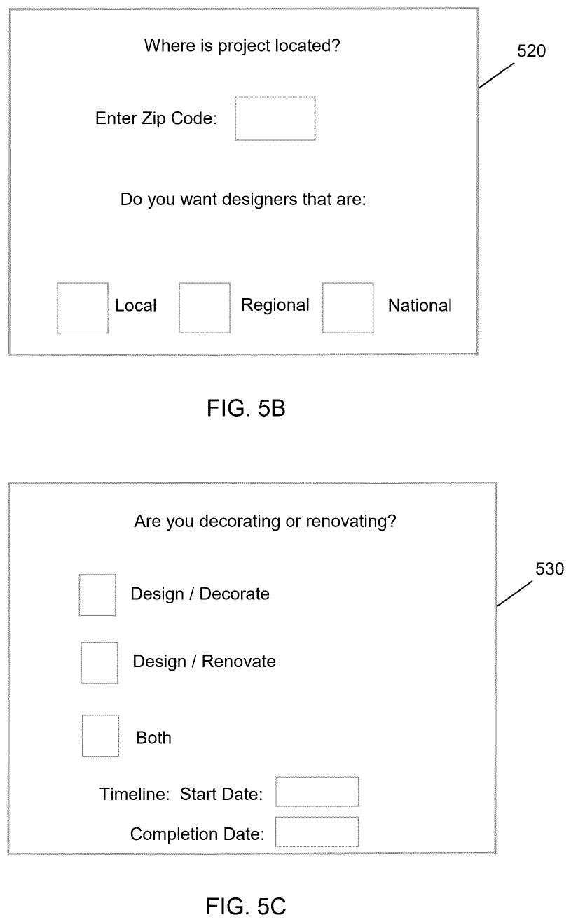

In a further feature, a user may only have to provide initial identification information, such as, a name or email address, to initiate an online design project match operation. Control may then proceed to routine 400 to begin. A user can join later by submitting a complete user profile. FIG. 5 shows an example display view 500 of a user-interface having text boxes that enable a user to input name and email address to enroll on platform 120. A button 510 or other type of user-interface element may be used to enable a user to select to join the online design project service 110 hosted on platform 120. Alternatively, a user can bypass joining now and instead join later after some candidate designer matches have been identified but before the designer matches are revealed to the user.

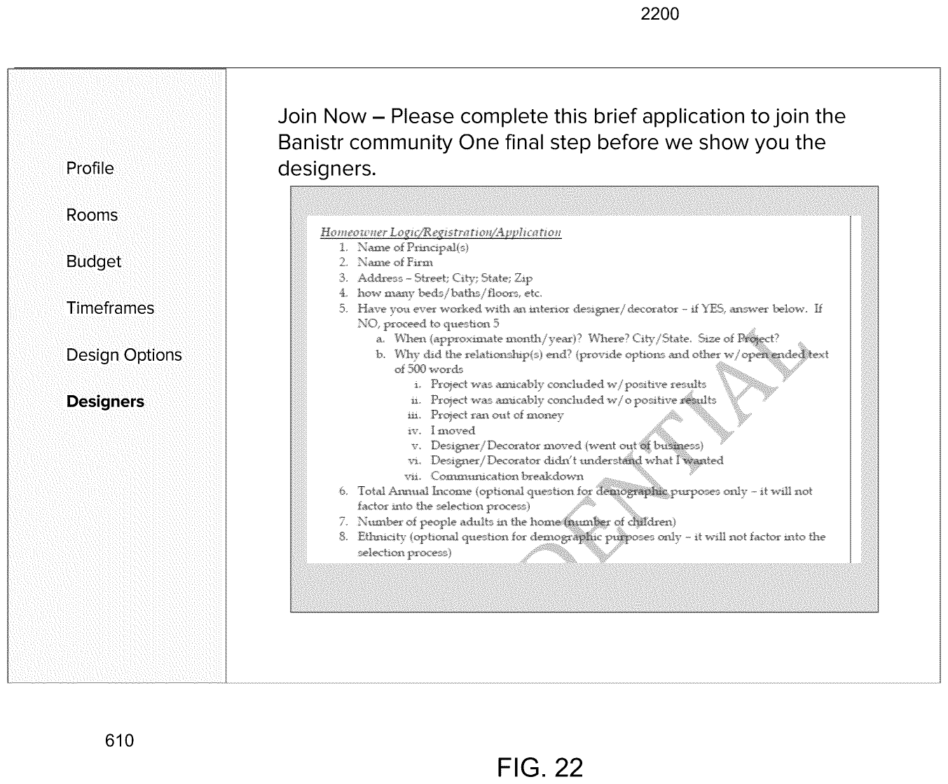

When a user selects to join, a user profile is then built (step 320). Application 102 may provide a series of user-interface elements, such as, one or more graphical user displays, that enable a user to view information and enter user inputs to build a user profile. For example, one or more display views can be presented that enable a user to enter user profile information. User profile information may include, but is not limited to, client information, design project information, design project images, queries on whether a client has worked with an interior designer/decorator and what types of projects the client has been involved with, income or finance information, or other information relevant to a design project and potential match with designers. FIG. 22 shows an example of an application form that can be used to obtain user profile information from a client and to build a user profile in step 320. In one embodiment, user profile information captured in step 320 using application 102 can be sent to matching manager 122 in platform 120 and stored in database 124 (step 350) for later retrieval and use by matching manager 122.

In step 330, one or more users that offer designer services (referred to herein as designers/decorators or designers/renovators) are enrolled into the online design project matching platform 120. For example, a designer can download and open an application 102 on a device 101. Application 102 and platform 120 then communicate with one another to provide output from platform 120 to application 102 and to provide input from a designer using application 102 to platform 120. Application 102 may provide a series of user-interface elements, such as, one or more graphical user displays, that enable a designer to view information and enter user inputs. For example, to enroll a designer in step 330, application 102 may output one or more display views that enable a designer to create a new account or access an existing account on platform 120.

When a designer selects to join, a designer profile is built as part of onboarding a designer onto platform 120 (step 340). Application 102 may provide a series of user-interface elements, such as, one or more graphical user displays, that enable a designer to view information and enter inputs to build a designer profile. For example, a tab, menu, button, or other user-interface element may enable a designer to select a designer's option to access a series of designer related display views. One or more display views can be presented that enable a designer to enter designer profile information. Designer profile information may include, but is not limited to, designer business information, contact and location information, design project experience, what types of projects and styles and budgets the designer has been involved with, Of other designer portfolio information, or other information relevant to a design project and potential match with homeowner/residential or commercial clients.

In one feature, a designer can specify minimum project budgets for new clients, budget ranges by scope of project, whether the designer will handle a whole or part of a unit, and types of styles and spaces the designer is willing to handle.

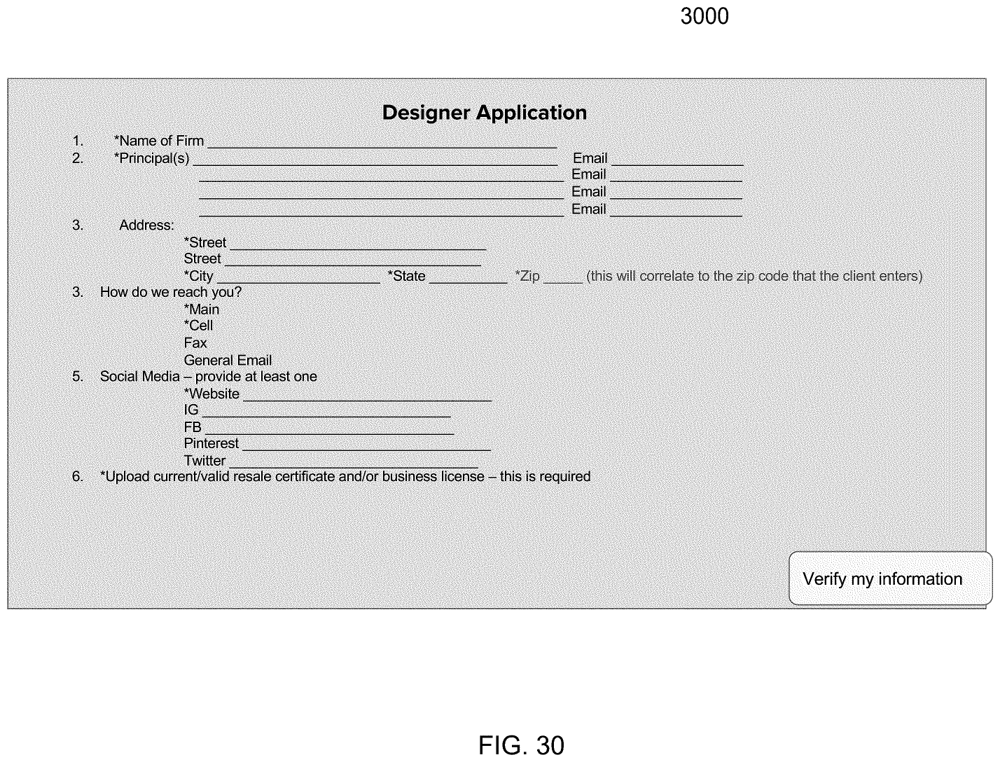

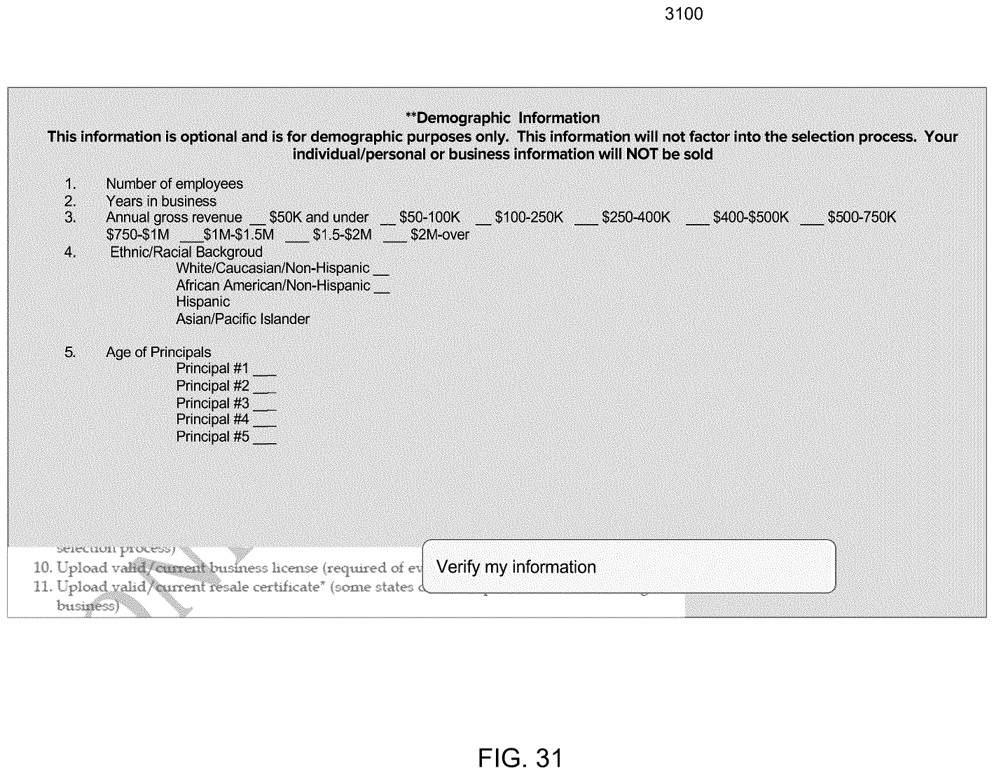

FIGS. 30-40 shows examples of display views that can be used to build a designer profile in step 340. FIG. 30 shows an example of an application form 3000 that can be used to obtain designer profile information. The designer application form can request and obtain information from a designer relating to a designer business, contact and location information. Location information may include for example zip code, address, city/state, country, neighborhood, latitude/longitude or other location information. An upload option may be provided to enable a designer to upload a current business license or certificate. FIG. 31 shows an example of a form 3100 that can be used to obtain demographic and business information about a business for its designer profile. Demographic information may be information on ethnicity or race, age of principals or other demographic information. Business information may be number of employees, years in business, or annual gross revenue. Control elements, such as a button, may be added in display views in FIGS. 30 and 31 to enable a designer to verify information prior to sending it to platform 120 for storage. When a designer selects to verify information, designer profile information that has been entered is internally displayed for review and confirmation.

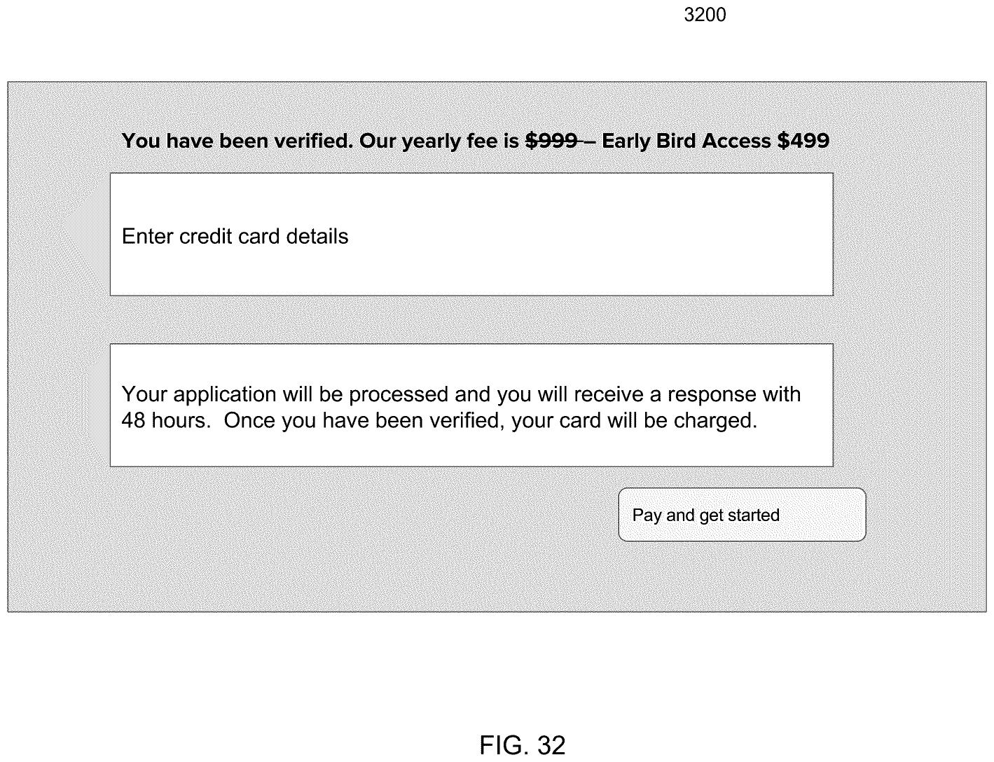

Once verification is completed, a designer that joins service 110 supported by platform 120 is then charged a fee. For example, as shown in the display view 3200 of FIG. 32, a yearly fee may be charged and options for remitting payment by a credit card, an online payment service, or other means of payment may be provided.

In a further feature, once a designer is enrolled and a designer profile is built, additional information about a designer's portfolio and types of design projects that designer is willing to accept for new clients is captured. This additional information can be added to the designer profile information in step 340.

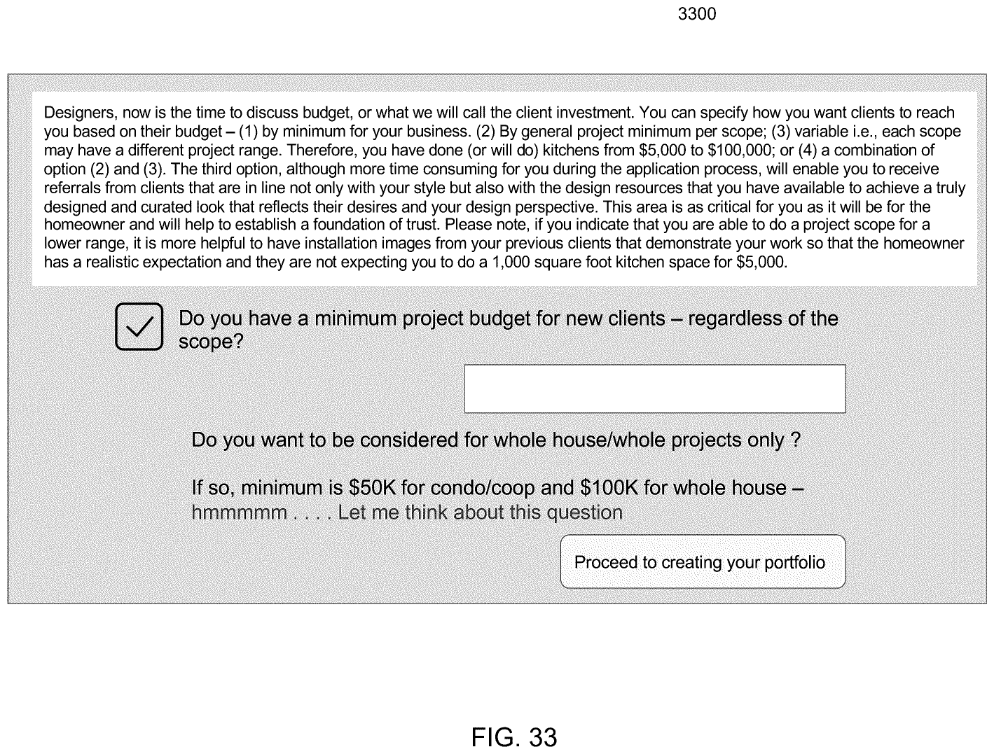

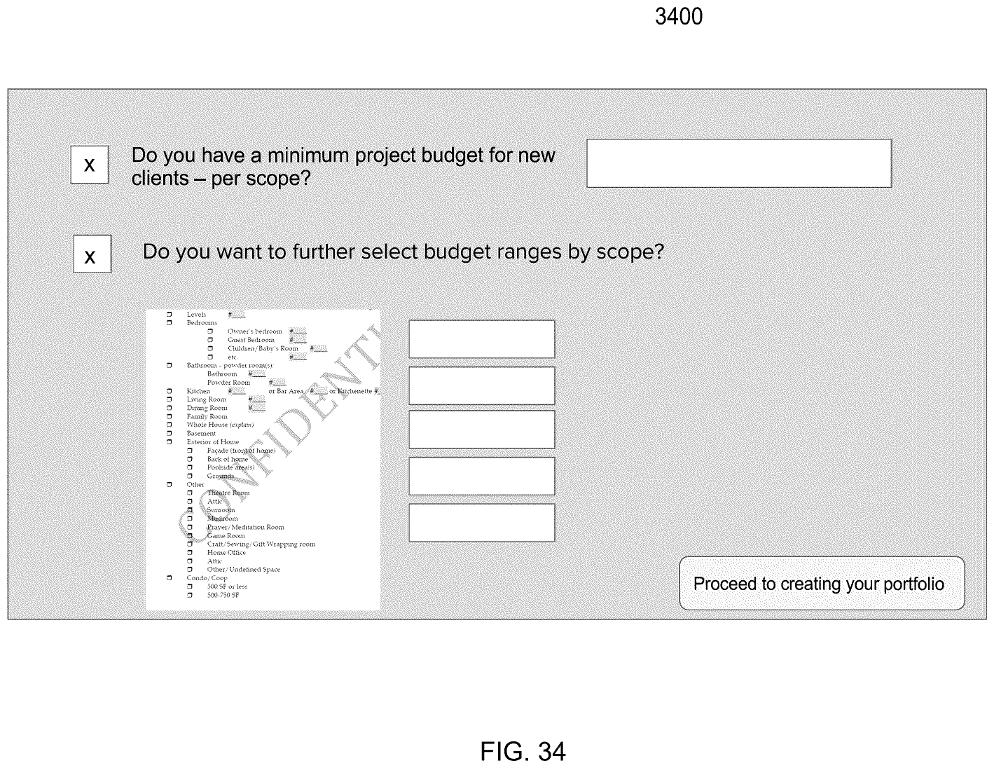

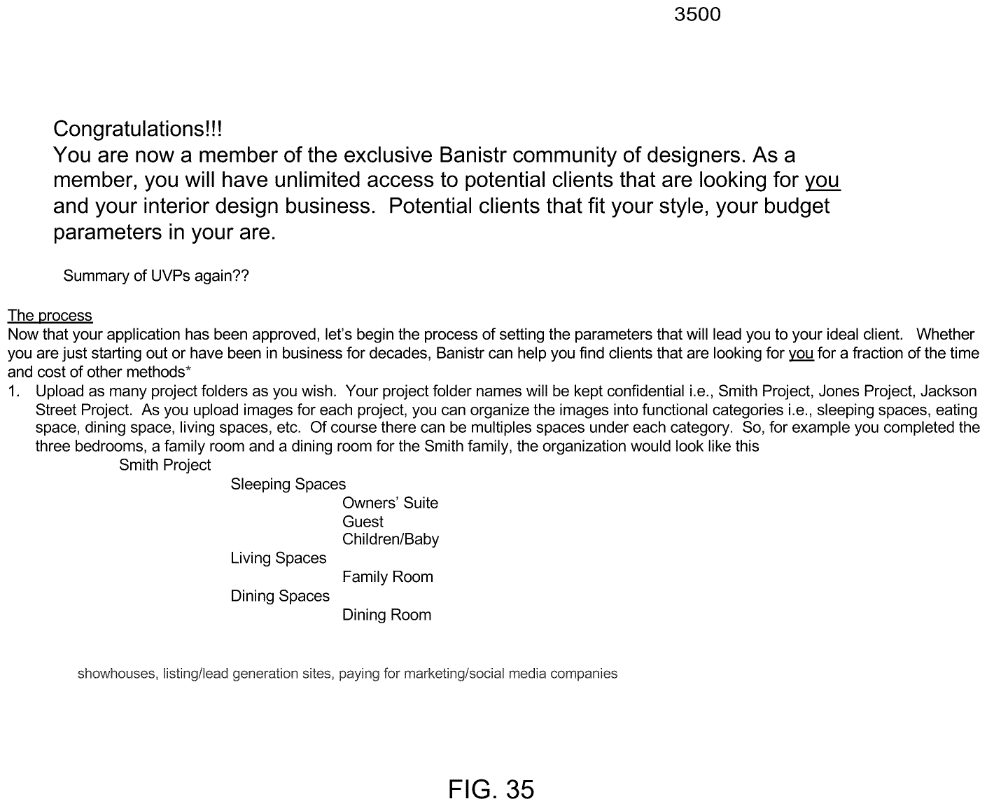

For example, as shown in FIGS. 33-34, one or more display views 3300, 3400 with user-interface elements can be output by application 102 to enable a designer to specify minimum project budgets for new clients (FIG. 33), identify whether the designer will handle a whole or part of a unit (FIG. 33), and identify budget ranges by scope of project (FIG. 34). A display view 3500 can then be output that confirms acceptance of a designer application or membership of the designer in the service 110 (FIG. 35).

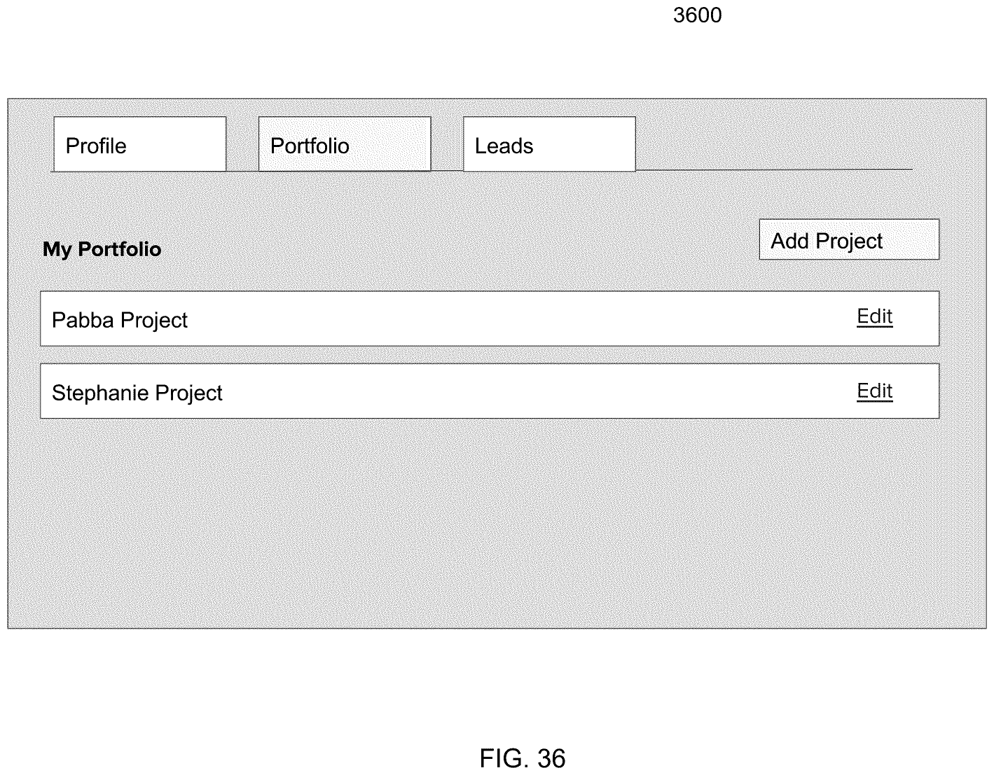

In further feature, once a designer is accepted into service 110, one or more display views with user-interface elements can be output by application 102 to enable a designer to identify types of styles and spaces the designer is willing to handle and to upload portfolio information including one or more projects a designer has installed/managed as shown in FIGS. 36-40. For example, as shown in display view 3600 in FIG. 36, a Portfolio tab may be presented in application 102 to a designer to allow the designer to input information about their portfolio on platform 120. When a designer selects the Portfolio tab, a display view showing the designer portfolio information and any of one or more projects is displayed (FIG. 36). For example, one or more existing projects (i.e., Jones and Smith) may be displayed along with an Edit button to allow a designer to edit the details on existing projects including, but not limited to the design aesthetic, what was done as part of the decoration (drapery, furniture, etc.) or renovation (removing/adding walls, etc.), the investment range for each completed space or the ability to add rooms to existing projects i.e., Jones Bathroom, Jones Living Room; Smith Basement Renovation, Smith Kitchen, etc. A button labeled “Add Project” may enable a designer to add a new project to the portfolio.

Consider one example where a designer elects to upload project information relating to an earlier design project for the Smith family project that the designer wishes to be included in its portfolio as a representative example for matching with new potential design projects. As shown in display view in 3500 in FIG. 35, the Smith family design project may be organized into functional categories, such as, sleeping spaces, living spaces, and dining spaces. One or more spaces can be included in each category. For example, as shown in FIG. 35, sleeping spaces may include three spaces for an owner's bedroom suite, guest room, and children/baby room. A living space may be family room and a dining space a dining room. This new Smith project information can then be added as a new project or added as an edit to an existing project. The designer will also be able to sort their projects based on type of project (residential/commercial), style, scope and client investment.

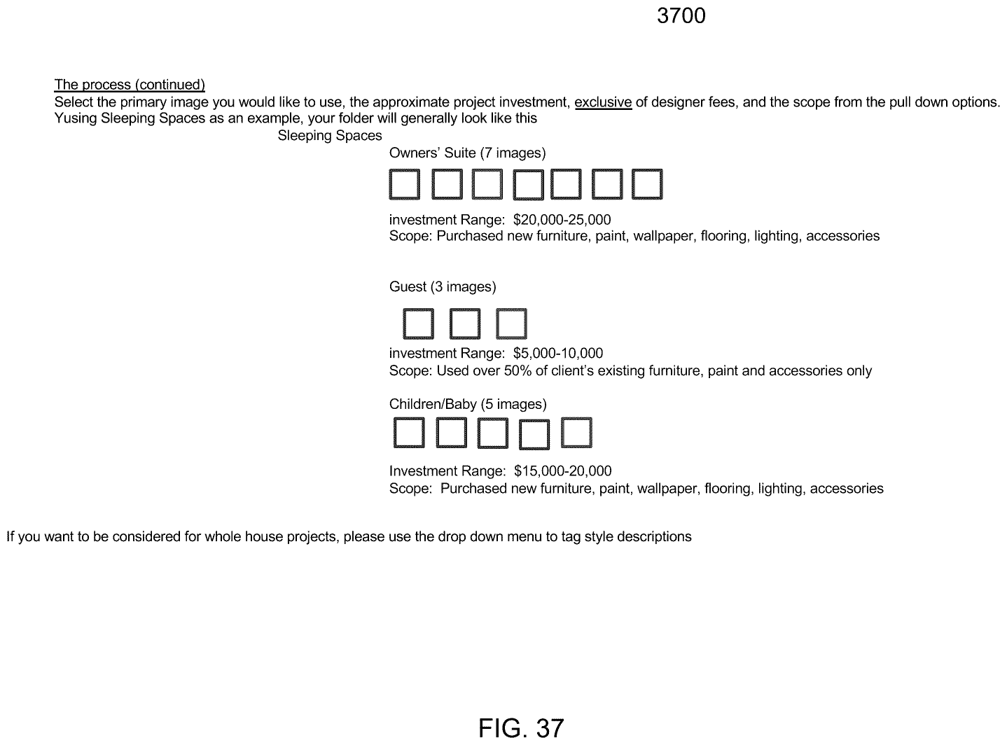

Once one or more projects have been uploaded, a designer may select which images are presented to potential new clients along with the identified categories, budget ranges, and scope of work information. As shown in the example of FIG. 37, a display view 3700 may be output to a designer that includes multiple images (such as thumbnails) from which a designer can select one or more of those images to be representative images to be used for each category. In the Smith family project example described earlier, one or more images for each of the different spaces (owner's suite, guest, and children/baby space) can be presented to allow a designer to select representative images.

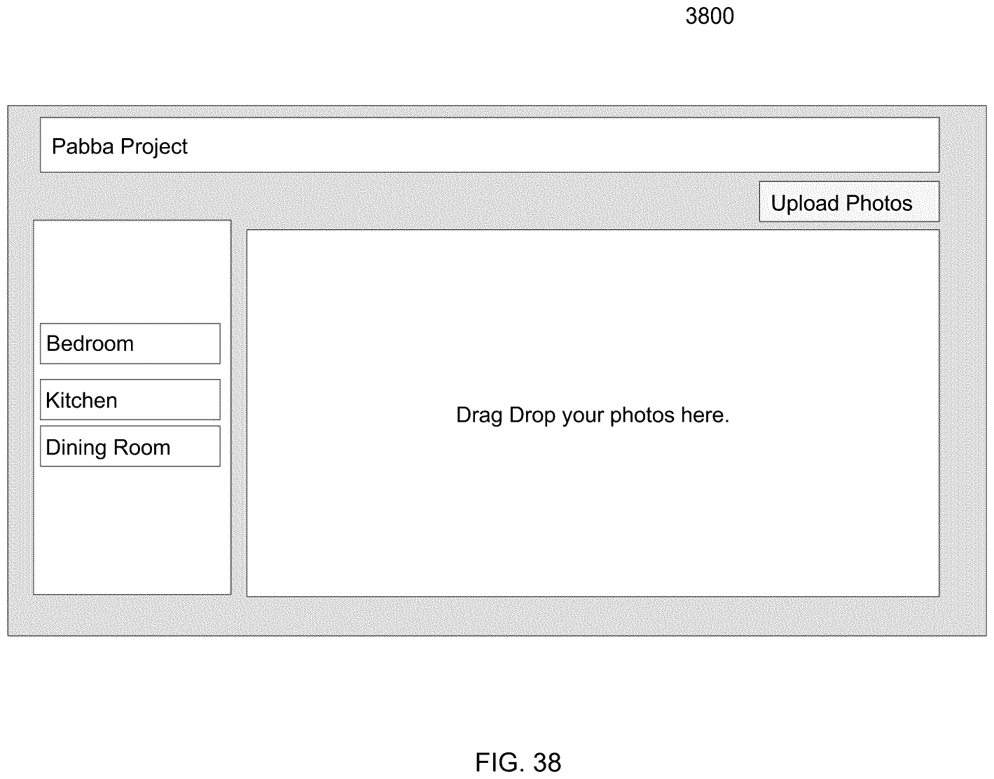

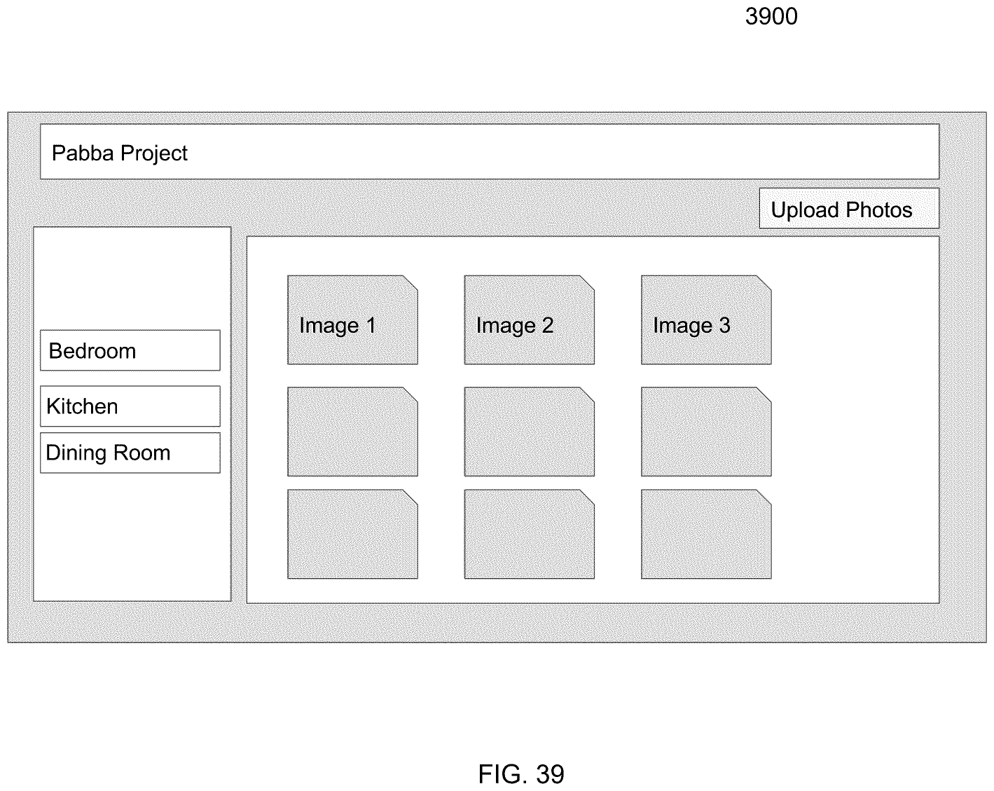

FIGS. 38-40 further show example display views 3800, 3900, 4000 that may be output by application 102 to allow a designer to build a new project. In FIG. 38, a display view 3800 allows a designer to upload photos for a particular living space. For example, an Upload Photos button may be used to allow a designer to upload photos from a directory. A display area may also be used to allow a designer to drag and drop photos too. A menu or other user-interface element may be used to specify which category the uploaded photos are to be associated with. For example, a designer can select one or more spaces, such as, bedroom, kitchen, or dining room, in the FIG. 38 display view. A further display view 3900 can then be presented which shows a summary of all images for the spaces of a project as shown in FIG. 39.

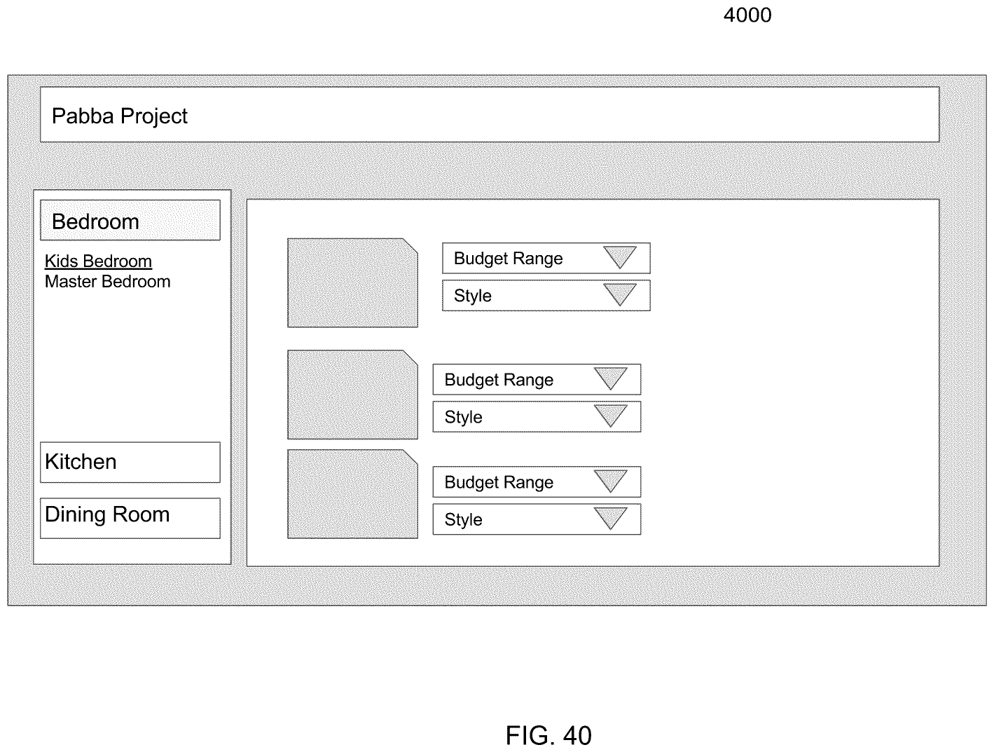

Finally, a display view 4000 may be output to a designer for a project, that enables to the designer to see for each space, the associated images in a folder icon, along with pull down menus to enable the designer to select whether to add or edit budget range information or style information as shown in FIG. 40. The added or edited project information may be included in the design profile information (step 340).

In one embodiment, designer profile information captured in step 340 using application 102 can be sent to matching manager 122 in platform 120 and stored in database 124 (step 350) for later retrieval and use by matching manager 122.

One technical advantage in embodiments is the designer profile information including the categories and representative images for projects in database 124 enables computationally efficient and fast matching by platform 120 (and in particular matching manager 122) with new candidate projects proposed by users of platform 120 looking for designers. Matching manager 122 to find a matching candidate designer only has to search categories and representative images of potential designers to find matches. The categories and representative images is a much smaller corpus of information to search. A further technical advantage is obtained because the additional matching based on budget/investment range, project scope (scope of work), design style/aesthetic and location information is also computationally efficient and fast.

### Matching

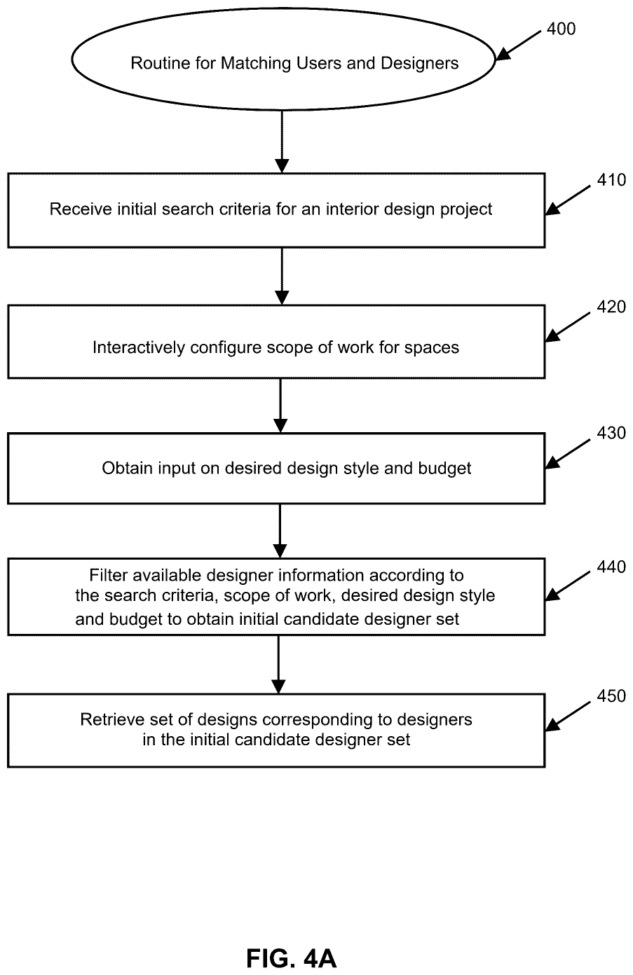

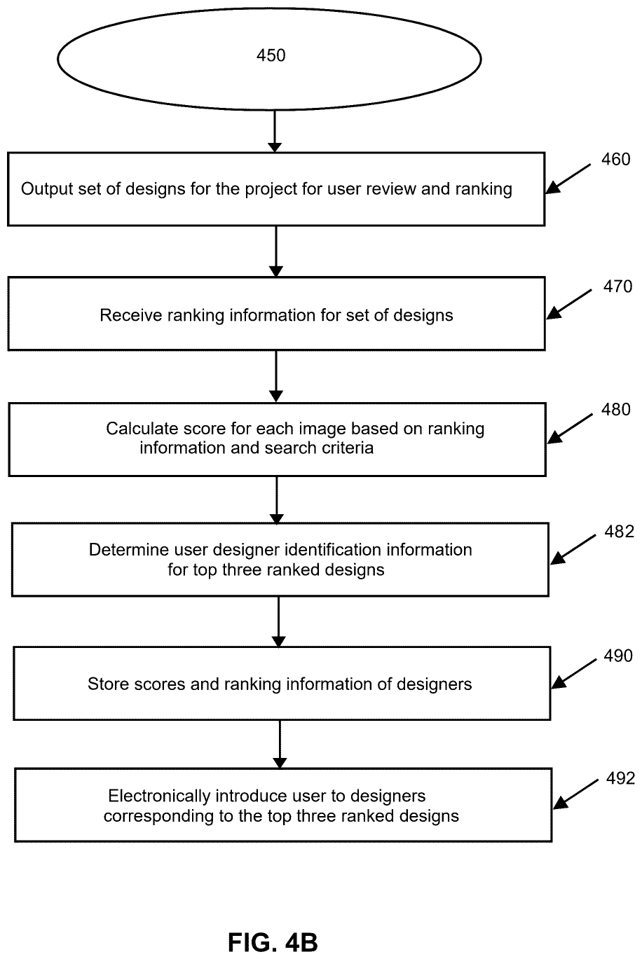

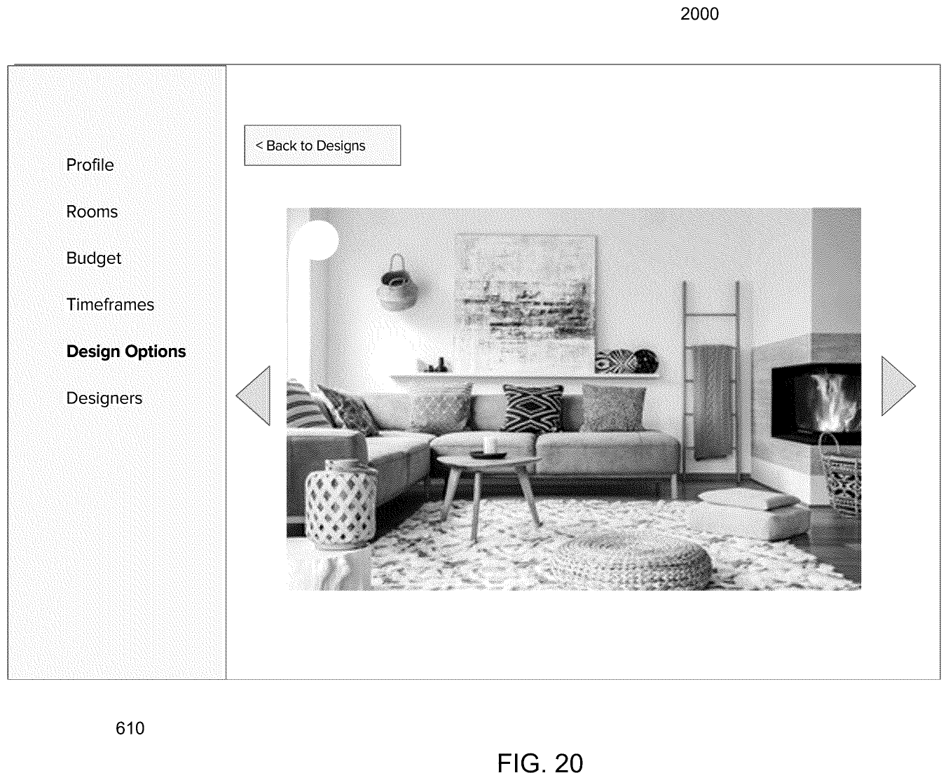

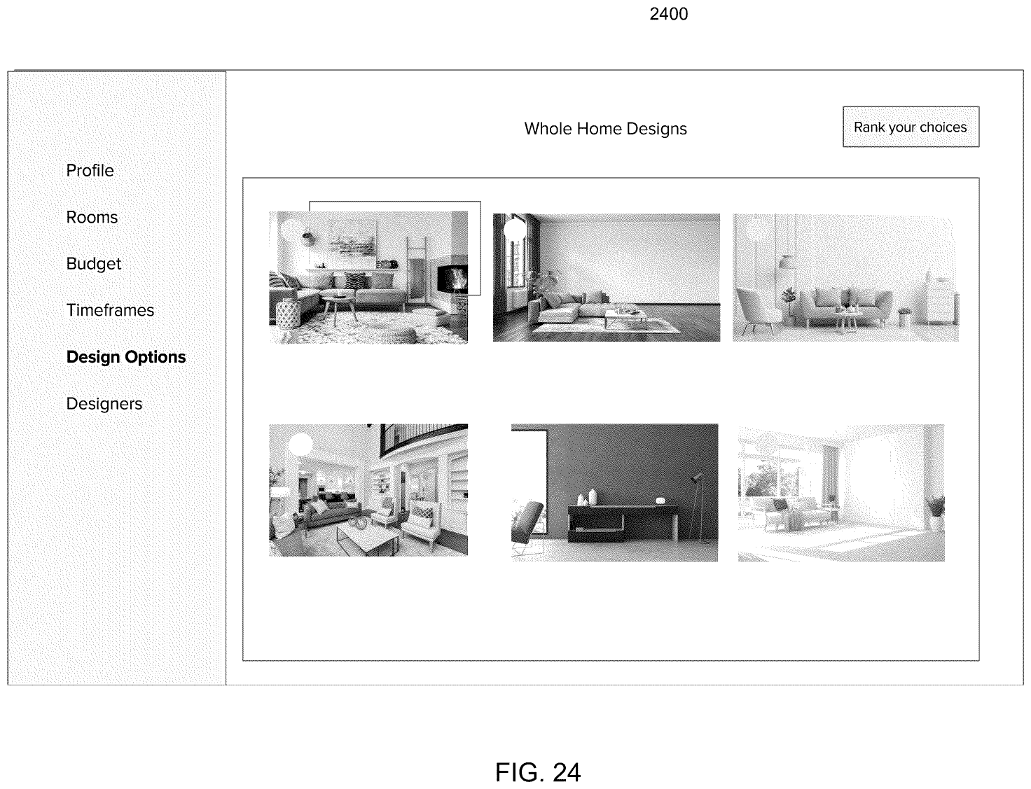

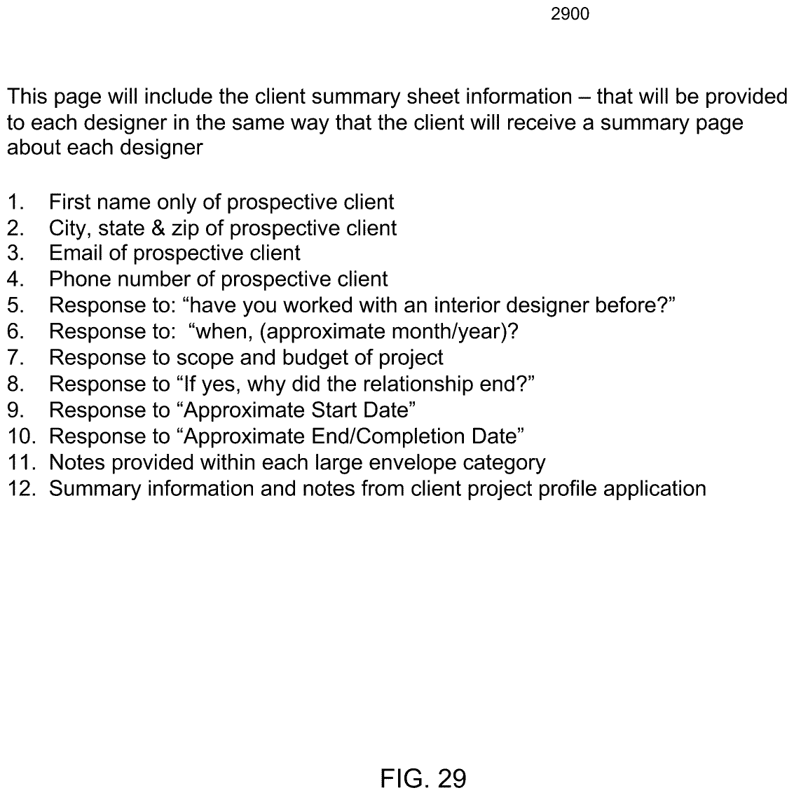

FIGS. 4A and 4B are a flowchart diagram of a routine 400 for matching users and designers with an online design project matching platform according to an embodiment (steps 410-492). In one embodiment, routine 400 is carried out by system 100 as described herein. Matching routine 400 is also described for brevity with respect to example user interfaces shown in FIGS. 5-28 and example client information provided to designers shown in FIG. 29. However, routine 400 is not necessarily limited to system 100 or these example user-interfaces as other system configurations and examples may be used as would be apparent to a person skilled in the art given this description.

The described features in the computer performance increase for the matching operation offer several benefits that enhance the efficiency and effectiveness of the system:
Location-Based Search: By allowing users to input location information (such as a zip code) for their design project, the system can perform a location-based search for designers. This reduces the search space and narrows down the potential designers, leading to faster and more relevant matches.
Automated Location Retrieval: The system can automatically retrieve location information from the user's profile or device, minimizing the need for manual input and improving the user experience.
Customizable Search Radius: Clients can specify their preferred search radius (local, regional, national, or international). This customization allows clients to find designers that are geographically close or align with specific project requirements.
Clear User Interface: The user interface provided by the application allows users to easily input their location information and select the search radius. Clear user-interface elements, such as checkboxes and radio buttons, make the process intuitive and efficient.
Design/Decoration and Design/Renovation Options: The system allows clients to specify whether they require a designer/decorator, designer/renovator, or a combination of both for their project. This specificity ensures that clients are matched with professionals who have the relevant expertise for their project scope.
Enhanced Definitions and Guidance: The user-interface elements include definitions of terms, providing clarity and guidance to clients during the selection process. This feature helps users make informed decisions, reducing confusion and potential mismatches.
Flexible Project Scopes: Clients can indicate a combination of design and renovation needs within the same project scope. This flexibility ensures that clients can find designers capable of handling multiple aspects of their project, leading to more comprehensive and efficient design solutions.
Additional Project Options: The system offers additional options for full or partial design-build/renovation and RFP bidding processes for residential and commercial projects. These options cater to different project types and provide a broader range of design services to clients.
Utilization of a budget tool applied to the scope of work: The system offers the homeowner and the design professional the ability to apply real budget/investment parameters to the project scope. This provides the homeowner and the design professional with a level of assurance that they can achieve the project goals within a financial range that they both agree on from the beginning. This enhancement is unique to the market enhancing the likelihood that the project will be aligned on this important factor.
Streamlined User Experience: By presenting user-interface elements on a remote device, the system streamlines the design matching process. Clients can easily select their preferences and search criteria, leading to quicker matches with suitable designers.
Effective Filtering and Ranking: The user-provided search criteria, such as location, design type, and project scope, contribute to effective filtering and ranking of designers. This focused approach improves the accuracy and speed of matching operations.
In conclusion, the described features in the computer performance increase for the matching operation ensure that clients can efficiently provide their preferences and requirements, enabling the system to make better higher quality and focused matches between clients and designers for architectural design projects. The user-friendly interface, location-based search, and customizable options enhance the overall user experience, leading to more successful and satisfying design outcomes. Additionally, the system's capability to handle different project scopes and service options caters to a broader range of clients and design needs.

As shown in FIG. 5A, application 102 may output a display view 500. Display view 500 includes user-interface elements that enable a user to input user identification information, such as, name and email address, which can be used by platform 110 to authenticate the user if already enrolled or to enroll a new user. A join now button 510 may be used to allow a user to begin matching operation by matching manager 122.

### Initial Search Criteria

When matching operation (routine 400) begins, as shown in FIG. 4A, in step 410, matching manager 122 receives initial search criteria for an interior design/decoration or interior design/renovation project.

In one embodiment, the initial user search criteria is location information. In step 410, location information is received. Location information may be obtained automatically from stored user profile information in database 124 or from a location identified from the user device 101 or the application 102, or location information input by the user through application 102. For example, when beginning an online design project match, application 102 may ask the user client to input location of the property address (such as a zip code) to be matched for a design project as described earlier and then select whether they want their search for designers to be local i.e., 50 miles radius or less; regional i.e., 50-100-mile radius; national i.e., 100 mile or more radius or international. In one example, the application finds designers within a local radius i.e., 50 miles or under from the property zip code. In other embodiments, the user will be given the additional options of a regional search i.e., 50-100-mile radius; national search i.e., more than 100 miles or international.

When matching operation (routine 400) begins, as shown in FIG. 4A, in step 410, matching manager 122 receives initial search criteria for an interior design/decoration or interior design/renovation project.

In one embodiment, the initial user search criteria is location information. In step 410, location information is received. Location information may be obtained automatically from stored user profile information in database 124 or from a location identified from the user device 101 or the application 102, or location information input by the user through application 102. For example, when beginning an online design project match, application 102 may ask the user client to input a location of the property address (such as a zip code) to be matched for a design project as described earlier and then select whether they want their search for designers to be local i.e., 50 miles radius or less; regional i.e., 50-100-mile radius; national i.e., 100 mile or more radius or international. In one example, the application finds designers within a local radius i.e., 50 miles or under from the property zip code. In other embodiments, the user will be given the additional options of a regional search i.e., 50-100-mile radius; national search i.e., more than 100 miles or international.

As shown in FIG. 5B, application 102 may output a display view 520. Display view 520 includes user-interface elements that enable a user to enter location information (such as a zip code) and select whether a search is to be local, regional or national.

Additional initial search criteria may be added in step 410. In one feature, a client user may identify if they want a designer/decorator or a designer/renovator (i.e., for a home design/decorate project or a home design/renovate project) or a combination of both decoration and renovation within the same project scope in the home i.e., the guest rooms will need decoration and the bathroom will require renovation. As shown in FIG. 5C, application 102 may output a display view 530 for access by the user on remote device 101. Display view 530 includes user-interface elements (such as check boxes or radio buttons) that enable a user to select either designer/decorator, designer/renovator or a combination of both decoration and renovation. Display view 530 may also include definitions of terms to help a client user to determine which one to choose. In further examples options to select for a full or partial design-build/renovation, RFP bidding process for residential and commercial projects, etc. may be added.

As shown in FIG. 5B, application 102 may output a display view 520. Display view 520 includes user-interface elements that enable a user to enter location information (such as a zip code) and select whether a search is to be local, regional or national.

Additional initial search criteria may be added in step 410. In one feature, a client user may identify if they want a designer/decorator or a designer/renovator (i.e., for a home design/decorate project or a home design/renovate project) or a combination of both decoration and renovation within the same project scope in the home i.e., the guest rooms will need decoration and the bathroom will require renovation. As shown in FIG. 5C, application 102 may output a display view 530 for access by the user on remote device 101. Display view 530 includes user-interface elements (such as check boxes or radio buttons) that enable a user to select either designer/decorator, designer/renovator or a combination of both decoration and renovation. Display view 530 may also include definitions of terms to help a client user to determine which one to choose. In further examples options to select for a full or partial design-build/renovation, RFP bidding process for residential and commercial projects, etc. may be added.

On one further feature, display view 530 may also include user interface elements such as, text boxes or calendars, to allow a user to input timeline information such as a start date and end date.

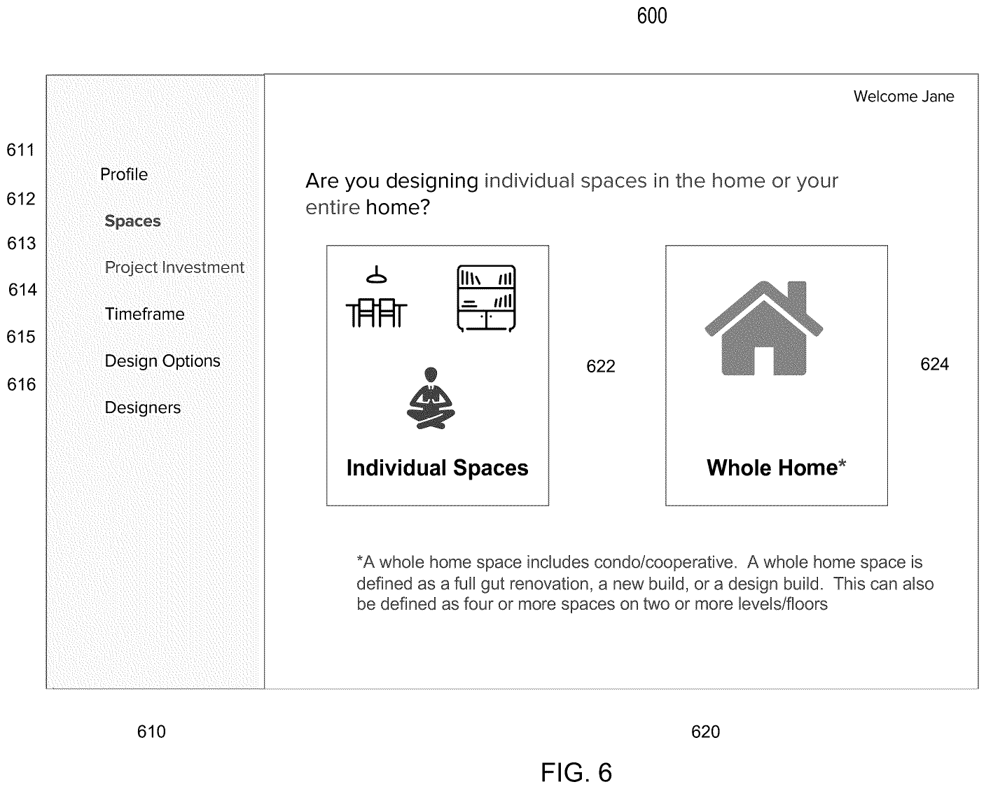

In another optional feature, shown in FIG. 6, a user may be provided with a display view 600 that enables to user to select to design individual spaces (button 622) or a whole space (such as a whole home) (button 624). Alternatively, the whole space option may be omitted, and control may be proceed without the selection.

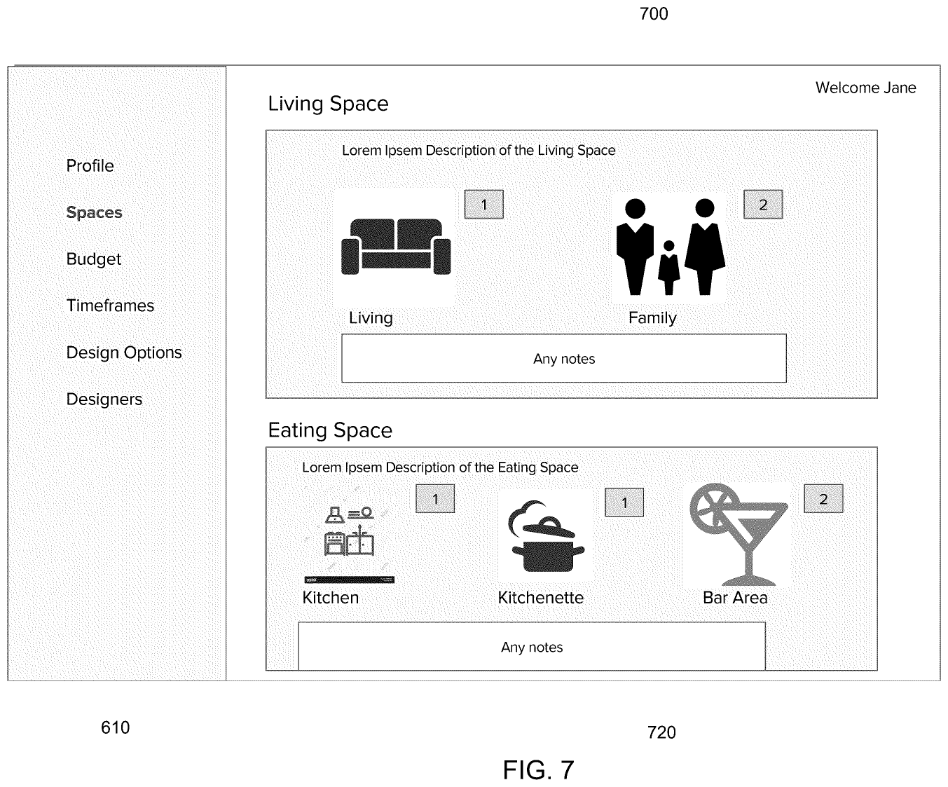

In step 410, if a user selects interior designer/decorator or interior designer/renovation or both for online design project matching in display view 530, a user is presented with a series of display views to enable a user to further configure the scope of work for particular spaces (FIGS. 7-12). This can include a series of display views that allow a user to input selections to identify the spaces to be included in the scope of work. These display views can include text, icons or graphical images, and user interface elements that allow a user to select one or more living spaces, eating spaces, bathing spaces, dining spaces, relaxing spaces, sleeping spaces, basement spaces, work spaces, attic or storage spaces, or other spaces. Notes and other information may be input too. In step 410, if the user selects the option for both interior design/decorate and interior design/renovate project, then once the user is presented with one or more display views to enable a user to further identify which option under the scope of work and budget for particular spaces.

In step 420, control proceeds to interactively configure a scope of work for spaces. The client user moves to a project scope section of the application. First, they identify what type of home the project is located in—single family home (SFH), condo, coop, townhome (other types of homes will be identified later). This initial search criteria may be input by a user seeking a designer through application 102 communicating with platform 120. In a further feature, the scope of work information includes identification of one or more spaces within a residence or a whole residence. Further search criteria may also be input with the scope of work, such as, budget or investment information. Budget or project investment information may be information identifying a budget range, budget cap, budget estimate, fixed fee, or other related financial term for the cost of the design project in the configured scope of work.

For example, when a user selects that the scope includes a combination of both decoration and renovation within the same project scope in the home i.e., the guest rooms will need decoration and the bathroom will require renovation. A pull-down menu or other option may be presented that will enable the user to select design/decorate for the guest rooms and design/renovate for the bathroom.

It is helpful to consider the selection of individual spaces in further detail. For example, FIG. 7 shows a display view 700 that allows a user to select a living space and/or an eating space to be included in the scope of work. A content display area 720 includes a living space panel and an eating space panel. The living space panel allows a user to identify and name the number of living spaces, a number of family members, and to input notes. The eating space panel allows a user to identify and name the number of eating spaces, such as, a kitchen, kitchenette, or bar area, and to input notes and upload photographs/images of the current space, if desired.

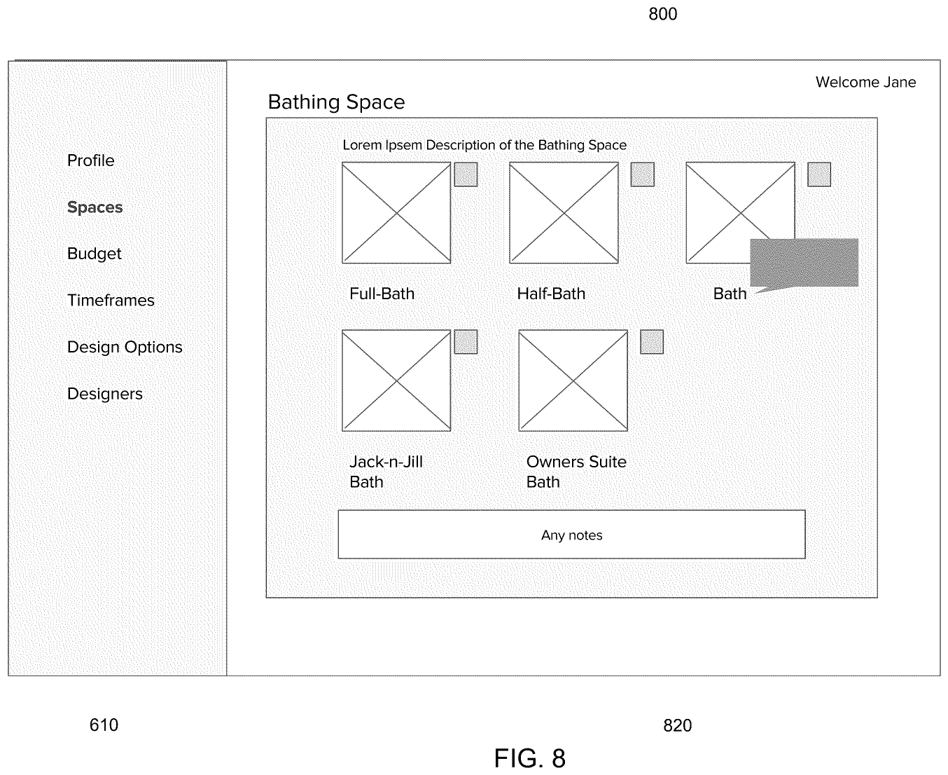

FIG. 8 shows a display view 800 that allows a user to select a bathing space to be included in the scope of work. A content display area 820 includes a bathing space panel that allows a user to identify and name the number of bathing spaces, such as, full bath, half-bath, bath, child's bath, owner's bath/suite and to input notes and upload photographs/images of the current space, if desired.

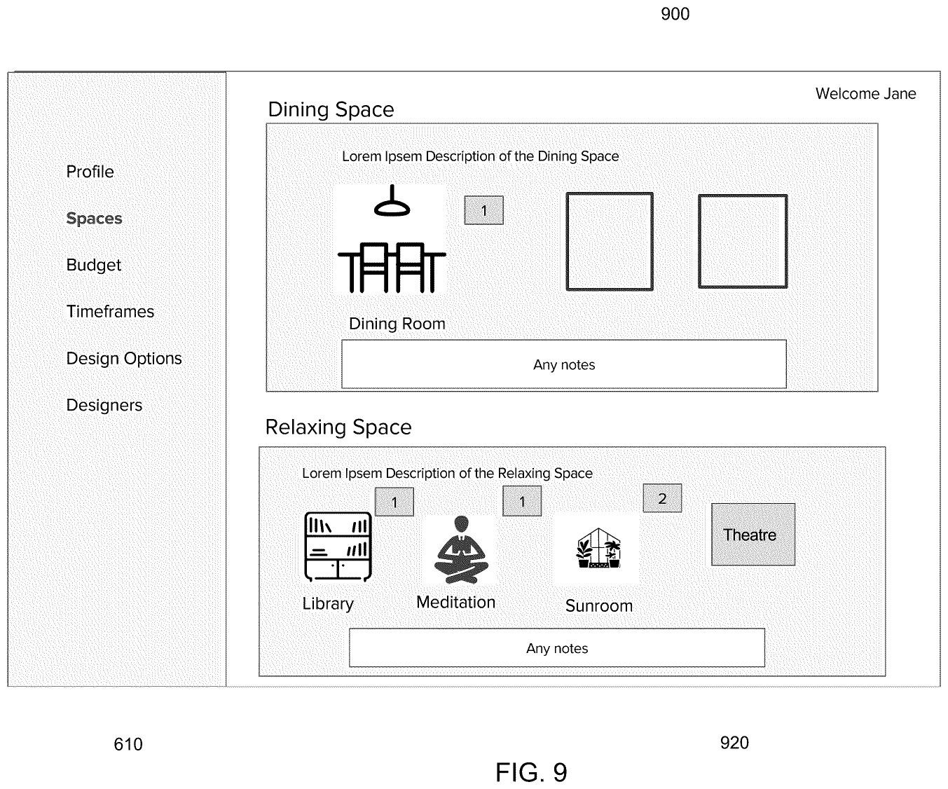

For example, FIG. 9 shows a display view 900 that allows a user to select a dining space and/or a relaxing space to be included in the scope of work. A content display area 920 includes a dining space panel and a relaxing space panel. The dining space panel allows a user to identify and name the number of dining spaces, such as, a dining room, and to input notes. The relaxing space panel allows a user to identify and name the number of relaxing spaces, such as, a library, mediation room, sunroom, or theatre, and to input notes and upload photographs/images of the current space, if desired.

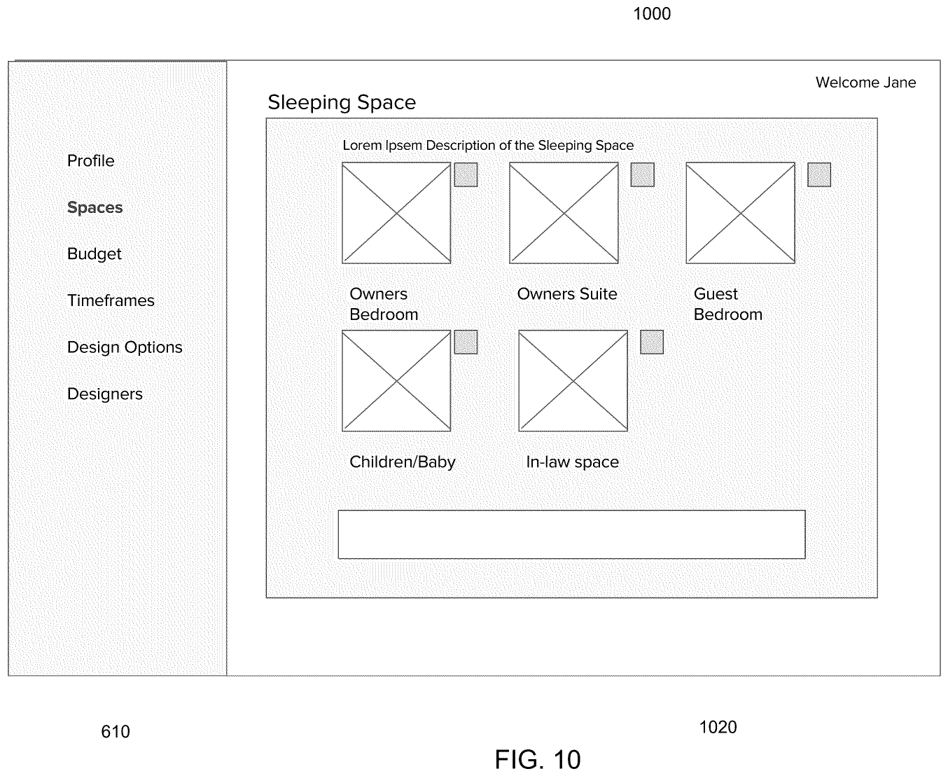

FIG. 10 shows a display view 1000 that allows a user to select a sleeping space to be included in the scope of work. A content display area 1020 includes a sleeping space panel that allows a user to identify and name the number of sleeping spaces, such as, owner's bedroom, owner's suite, guest bedroom, children or baby bedroom, or in-law space, and to input notes and upload photographs/images of the current space, if desired.

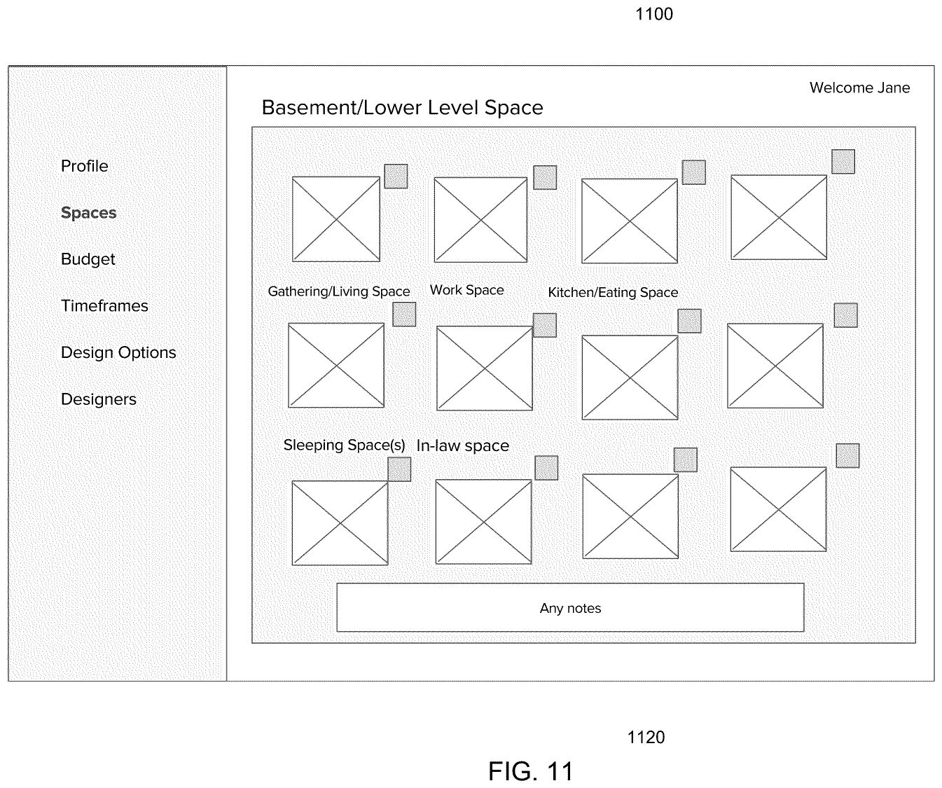

FIG. 11 shows a display view 1100 that allows a user to select a basement or lower-level space to be included in the scope of work. A content display area 1120 includes a basement space panel that allows a user to identify and name the number of basement or lower-level spaces, such as, gathering/living space, workspace, kitchen/eating space, sleeping space, in-law space or other space, and to input notes and upload photographs/images of the current space, if desired.

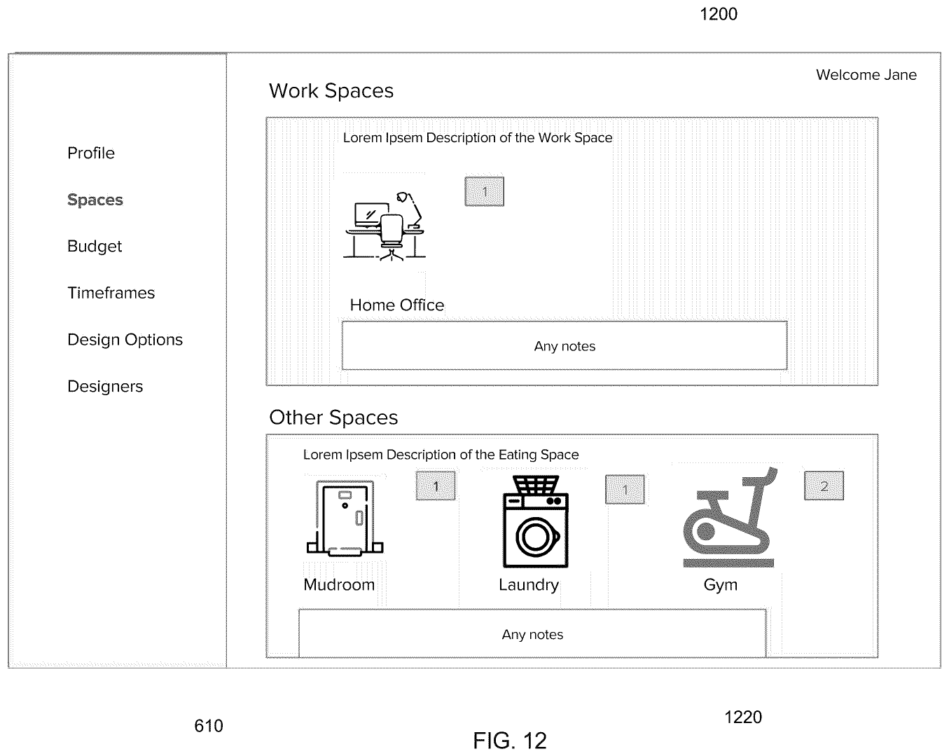

Finally, FIG. 12 shows a display view 1200 that allows a user to select a workspace and/or other spaces to be included in the scope of work. A content display area 1220 includes a workspace panel and other spaces panel. The workspace panel allows a user to identify and name the number of workspaces, such as, a home office, and to input notes and upload photographs/images of the current space, if desired. The other spaces panel allows a user to identify and name the number of other spaces, such as, a mudroom, laundry, and gym, and to input notes and upload photographs/images of the current space, if desired.

Another feature of the system, and particularly platform 120 and app 102 for example, is that instead of defining the scope of work using the word “rooms”, the user can define their scope of work through defining the spaces, allowing them to take an empty room and create it into the space that they desire. Thus, in addition to “standard/common” spaces i.e., eating, sleeping, dining, the homeowner can identify working, relaxing, family, etc. opening up the possibilities of design and what can be created in the home i.e., turning a kid's room into a home office or in-law suite.

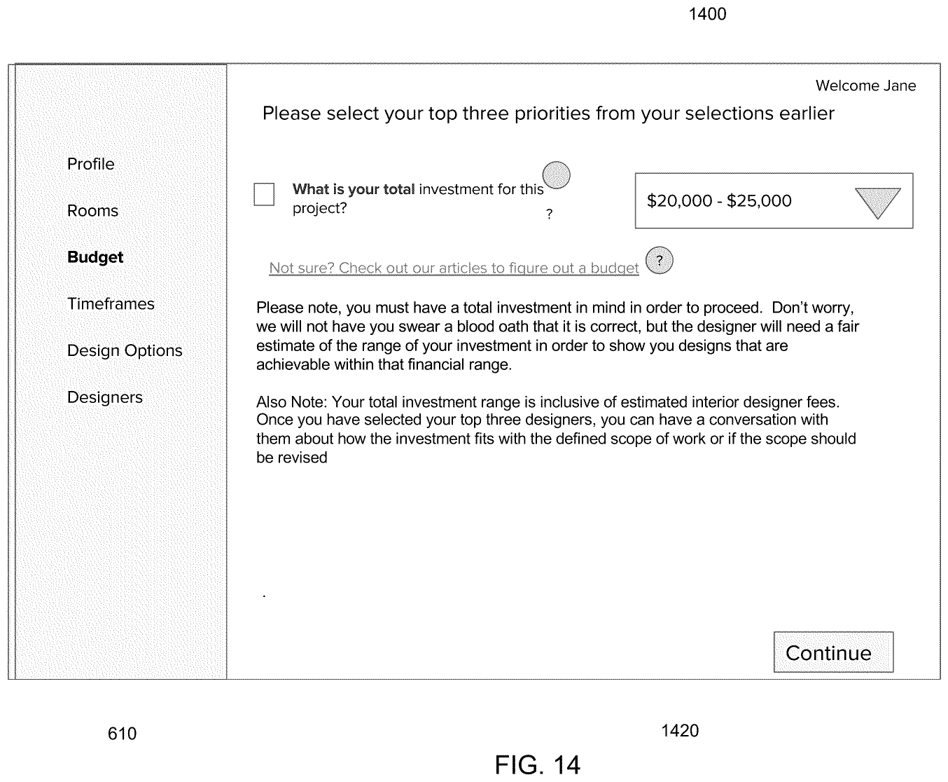

Once the individual spaces (or whole space) are selected for the scope of work, control proceeds to allow a user to input budget/investment information. For example, as shown in FIG. 14, application 102 may output a display view 1400 to allow the user input or select a budget/investment for the desired scope of work. For example, display view 1400 includes a panel 1420 having text and user-interface elements, such as, a menu or text box, that allow the user to input budget information, such as, a budget range or cap. This budget is included with the initial search criteria. In one example, the budget is associated with the entire scope of work for all the selected individual spaces. In this case, display view 1400 may appear after display view 1200. In another example, budget information is associated with the spaces corresponding to the top three priorities selected in step 420 described below and display view 1400 may appear after display view 1300 in step 420. The user will also be able to select the option that all of the spaces are a priority and the entire scope should be weighted equally by the algorithm.

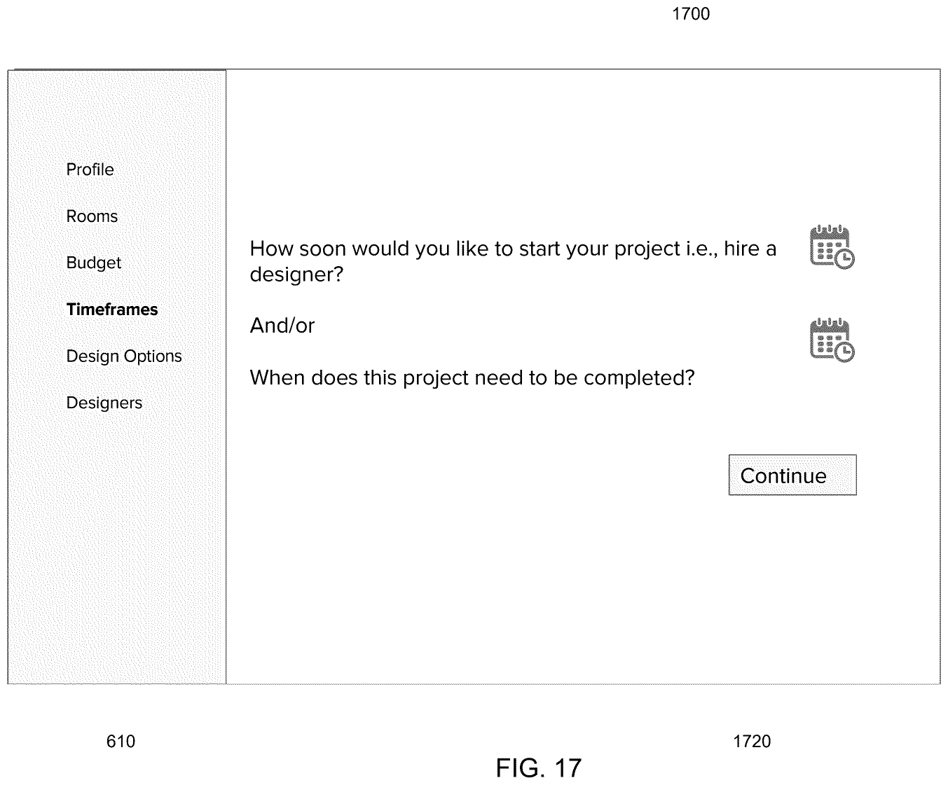

The client will then be asked if there is a timeframe that they would like to start and/or end the project. They can also skip this question if they are open to a start date. This information will not factor into the algorithm but will be reported out to the designers. In a further embodiment, a user may also be allowed to input information on timeframes of a desired design project. For example, as shown in FIG. 17, a display view 1700 may be output by application 102. Display view 1700 has a content area 1720 with text and one or more user-interface elements (such as, calendar buttons) that enable a user to identify when they wish to start the design project and when the project needs to be completed.

In an embodiment, application 102 enables a user to input initial search criteria through one or more display views. As shown in FIG. 6, a display view 600 has a control panel 610 and a content display area 620. Control panel 610 has selectable user-interface elements 611-616 (such as buttons or menu items) that allow a user to select to view or input information on a user profile 611, spaces 612, project investment or budget 613, timeframe 614, design options 615, and designers 616. For example, when a user selects a Spaces button 612, content display area 620 outputs text and user-interface elements to guide a user to enter information on a desired scope of work. In one embodiment, a user is queried on whether they wish to design/decorate individual spaces or design/renovate individual spaces and two buttons 622, 624 are provided to allow a user to input their respective selection in display area 620. Definitions of the two options will be provided to the user client to provide clarity on the options.

In step 420, matching manager 122 may further communicate with application 102 to output a display view to the user allow a user to identify or confirm three top priorities within the scope of work based on the input search criteria.

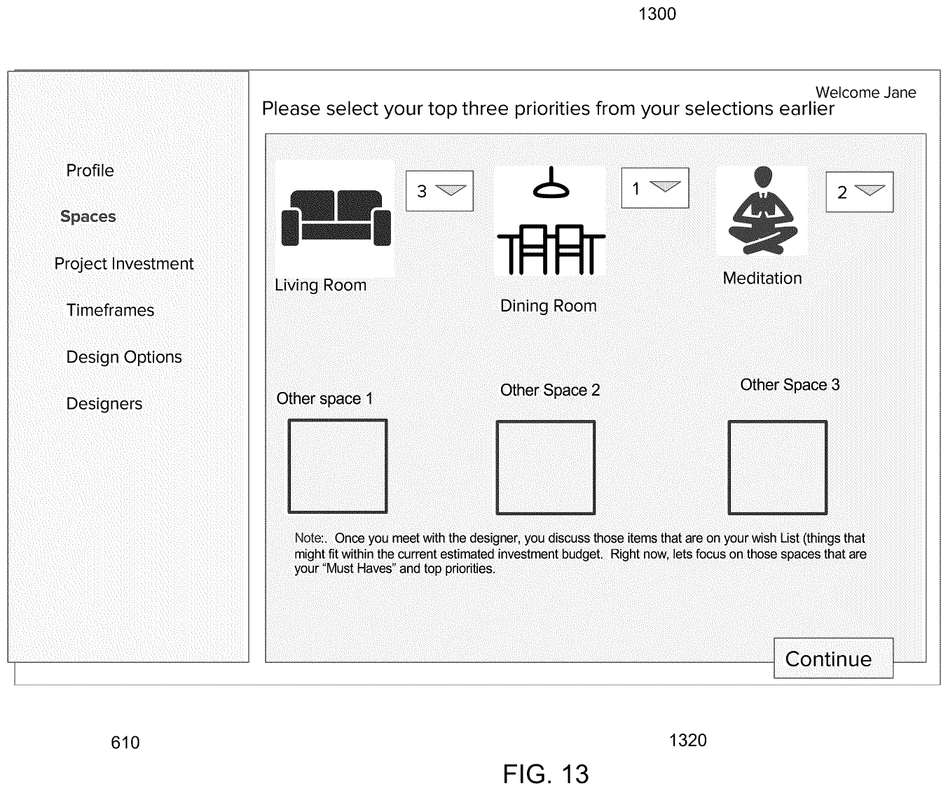

Consider the example described earlier with respect to FIGS. 7-12. Once a user has made selection and input a scope of work through display views 600-1200, application 102 can output a summary display view 1300 as shown in FIG. 13. Summary display view 1300 shows a panel 1310 having a summary of the spaces input in the initial scope of work in step 410. Display view 1310 further includes text and user-interface elements, such as, a menu or text box, that allow the user to select, rank, and/or confirm which spaces are in the top three priorities. Alternatively, matching manager 122 may automatically select the top three spaces according to predetermined criteria, a ranking algorithm, and/or user profile information.

Once initial search criteria is received (step 410) and the scope of work configured (step 420) for all the individual spaces, control proceeds to obtain further input on a design style (step 430).

### Design Style Input

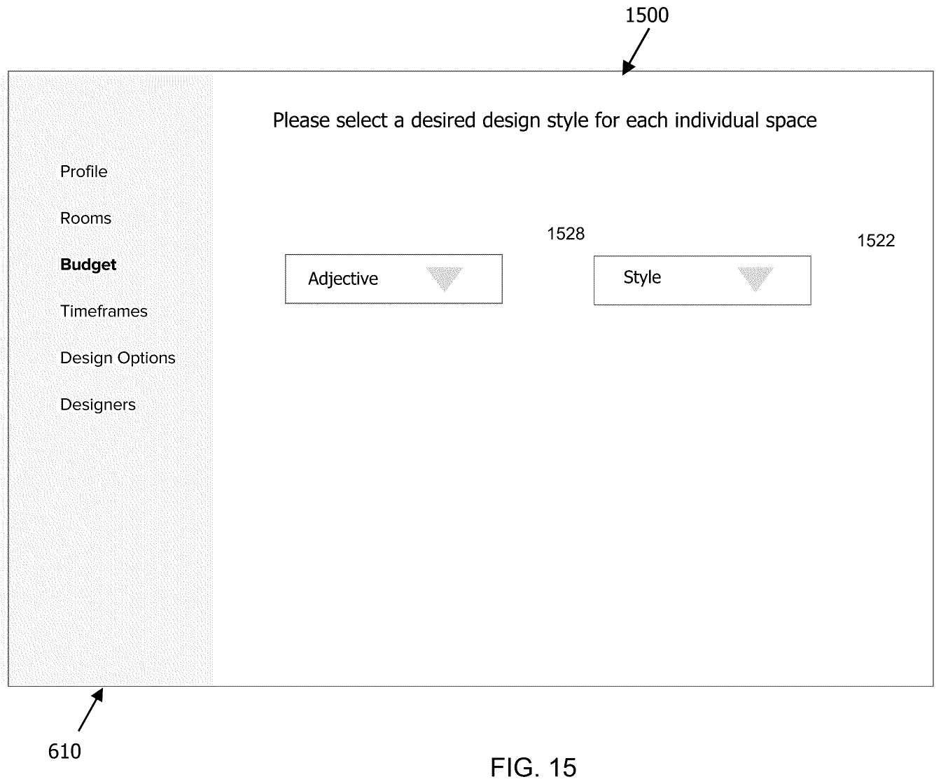

In step 430, input on a desired design style is obtained. Budget information may also be obtained. FIG. 15 shows a display view 15400 that allows a user to select a desired design style. A content display area 1520 includes a design style selection panel. The design style selection panel has text information and two user-interface elements 1522, 1524 which allow a user to select a design style. User-interface element 1522 enables a user to select a style category. For a style category may be selected from a set of style categories that include one or more of traditional, modern, contemporary, eclectic, boho, grand millennial, postmodern, bohemian, farmhouse, or classic. User-interface element 1524 enables a user to select an adjective to further characterize the design style. For example, an adjective(s) may be selected from a set of adjectives that include one or more descriptive words i.e., fun, colorful, adventurous, modern, sophisticated, clean, eclectic, classic, timeless, bold, serene, or peaceful. As shown in FIG. 15, user-interface elements 1522, 1524 may each be a pull-down menu, but other types of user-interface elements may be used.

In one embodiment, application 102 generates sets of style categories and adjectives based on predetermined data sets. In another embodiment, application 102 may generate the sets of style categories and adjectives based on a user profile information (such as preferences or past usage) or user input search criteria (such as location). Information trends and popular styles near a location may also be used to determine sets of styles and adjectives. An image is uploaded an AI generated data would view the images and generate the style categories and adjectives and then be able to create a design for their space using that image as the “guide” and also indicate the sources of the materials of the AI generated design.

In one exemplary implementation, pseudocode for generating sets of style categories and adjectives based on predetermined data sets and user profile information is as follows:

```
# Function to generate style categories and adjectives
function generateStyleSets( ):
  # Load predetermined data sets of style categories and adjectives
  predeterminedStyleCategories = loadPredeterminedStyleCategories( )
  predeterminedAdjectives = loadPredeterminedAdjectives( )
  # Generate sets based on predetermined data
  styleCategoriesSet = getRandomSubset(predeterminedStyleCategories, numCategories)
  adjectivesSet = getRandomSubset(predeterminedAdjectives, numAdjectives)
  # Retrieve user profile information or user input search criteria
  userProfile = getUserProfile( ) # Assuming this function retrieves user profile information
  userLocation = getUserLocation( ) # Assuming this function retrieves user location
  # Use user profile information to influence style sets
  userPreferredCategories = userProfile.preferredStyleCategories
  userPreferredAdjectives = userProfile.preferredAdjectives
  # Use user input search criteria (e.g., location) to influence style sets
  locationTrends = getStyleTrendsNearLocation(userLocation)
  # Merge user preferences and location trends into style sets
  finalStyleCategoriesSet = mergeSets(styleCategoriesSet, userPreferredCategories,
locationTrends)
  finalAdjectivesSet = mergeSets(adjectivesSet, userPreferredAdjectives, locationTrends)
  return finalStyleCategoriesSet, finalAdjectivesSet
# Helper function to load predetermined style categories and adjectives
function loadPredeterminedStyleCategories( ):
  # Load and return the predetermined style categories from a data source
  return [“Modern”, “Traditional”, “Minimalist”, “Industrial”, “Bohemian”, “Contemporary”,
“Scandinavian”, “Eclectic”, ...]
function loadPredeterminedAdjectives( ):
  # Load and return the predetermined adjectives from a data source
  return [“Elegant”, “Cozy”, “Rustic”, “Sleek”, “Luxurious”, “Warm”, “Chic”, “Vibrant”,
“Serene”, ...]
# Helper function to get a random subset of items from a list
function getRandomSubset(list, numItems):
  # Randomly select numItems items from the list
  shuffledList = shuffle(list)
  return shuffledList[:numItems]
# Helper function to shuffle a list
function shuffle(list):
  # Implement a shuffling algorithm to shuffle the list
  # ...
# Helper function to retrieve user profile information
function getUserProfile( ):
  # Retrieve and return user profile information from a data source
  # ...
# Helper function to retrieve user location
function getUserLocation( ):
  # Retrieve and return user location information from a data source
  # ...
# Helper function to get style trends near a location
function getStyleTrendsNearLocation(location):
  # Retrieve style trends and popular styles near the given location from a data source
  # ...
# Helper function to merge user preferences and location trends into style sets
function mergeSets(originalSet, userPreferences, locationTrends):
  # Merge user preferences and location trends into the originalSet
  # Adjust the weights of each item in the set based on user preferences and location trends
  # ...
```

Performance of the system is increased due to:
Predefined Data Sets: By loading predetermined data sets of style categories and adjectives, the code reduces the need for real-time data retrieval during the style generation process. This reduces the processing time and ensures that style sets are generated quickly.
Random Subset Selection: The code uses a helper function to randomly select a subset of items from the predetermined style categories and adjectives. This random subset selection helps in diversifying the generated style sets, enhancing the variety and suitability of the styles presented to users.
Efficient Data Retrieval: The code efficiently retrieves user profile information and location data from data sources, ensuring that the style sets are influenced by the user's preferences and location trends. By optimizing data retrieval, the code improves the overall performance of the style generation process.
Data Merging and Weight Adjustment: The code merges user preferences and location trends into the original style sets and adjusts the weights of each item based on this information. This step ensures that the final style sets are personalized and relevant to the user's preferences and location, leading to more accurate and satisfactory style recommendations.
Parallel Processing: While not explicitly shown in the pseudocode, the code can leverage parallel processing techniques when handling large data sets or multiple user requests simultaneously. This allows for efficient use of computing resources and faster style generation.

The pseudocode optimizes data handling, incorporates user preferences and location trends, and uses random subset selection to efficiently generate personalized and relevant sets of style categories and adjectives. These optimizations contribute to improved computer performance by reducing processing time, enhancing the user experience, and facilitating timely style.

Once a user selects a desired design style, information on the selection is stored by application 102 or sent to matching manager 124. Control then proceeds to step 440.

In step 440, matching manager 122 filters available designer information according to the input search criteria, configured scope of work, desired design style and budget to obtain an initial designer candidate set. For example, available designer information for the design project is filtered to obtain a set of initial designer candidates. In particular, available designer information is filtered according to the criteria input in step 410, scope of work determined in step 420 and the desired design style selected in step 430. In the example described above, where the filter criteria identifies the three top spaces (or if all of the locations are to be treated equally important) and location, and the budget, then the available designer information is filtered to determine an initial candidate designer set of designers for the different work spaces within a range of the location. In one embodiment, the filtering can be performed by matching manager 122.

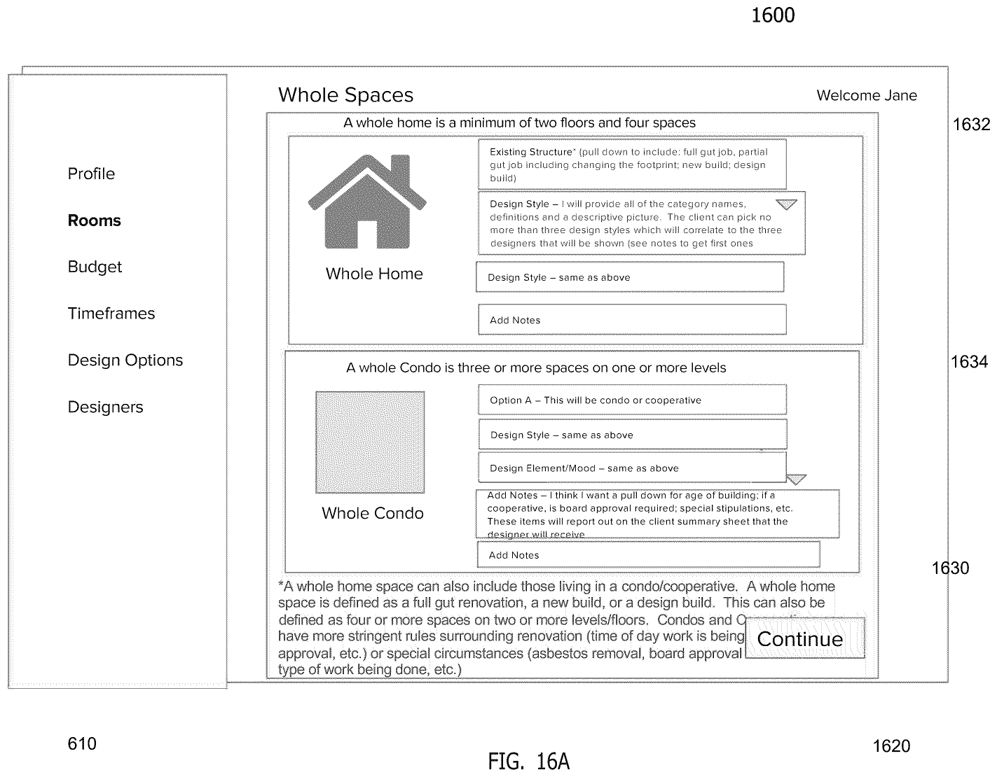

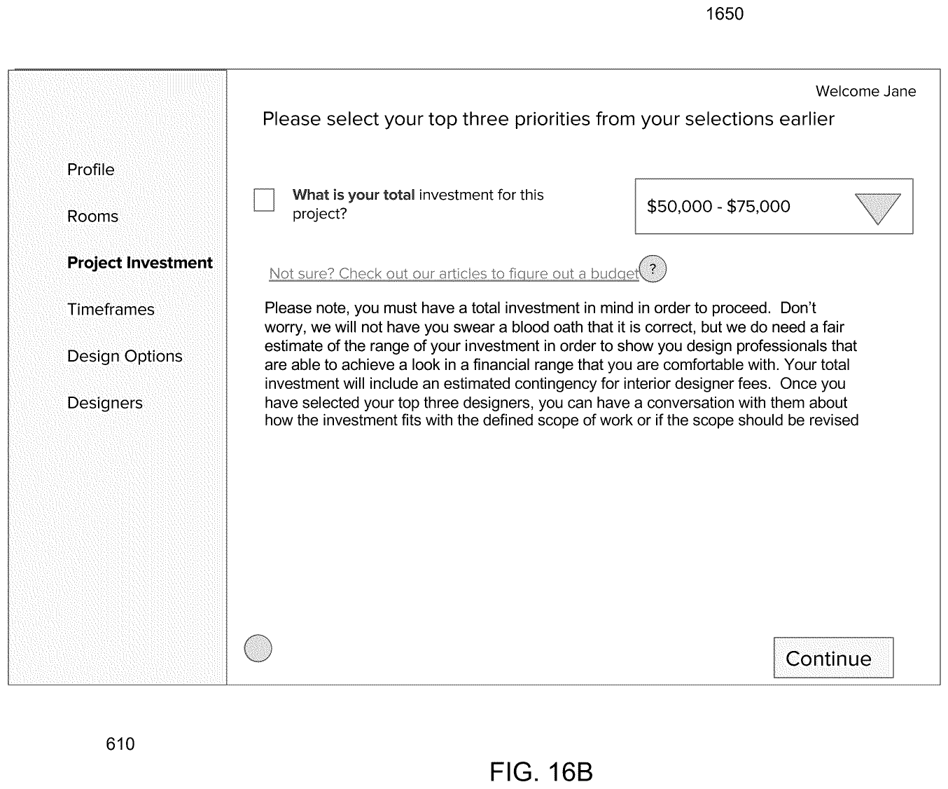

In a further embodiment, budget or project investment information may also be used to filter and obtain a set of candidate designers. As shown in FIG. 16B, control for matching an online design project for the design/decoration or design/renovation space or both decoration and renovation, can then proceed to provide a budget/project investment display view 1650. Display view 1650 includes a user-interface element, such as, a checkbox and pull-down menu to allow a user to indicate what a total investment for the project is including a budget range. The algorithm will match users, the scope of work that matches the scope of work and budget ranges input by the designer based on whether the project was decoration or renovation. Once the client has indicated the top three priorities within their scope or they have chosen to have all of the spaces in the scope equal in importance, the algorithm will mathematically calculate a score for this factor. Kitchens and bathrooms—whether renovated or decorated will be weighted and scored for the budget factor in the algorithm. Weighing the factors of renovated vs. decorated as well as kitchen and bath spaces as well as the size of the spaces in the algorithm will all factor into the project investment algorithm providing the user and the designer client with a balanced approach to the budget. The budget should also be scored i.e., how likely is the designer to achieve this look within the budget range. If the budget range is $10-15K and the image receives a ranking of 5 and the designer can achieve this design for $11K, then the algorithm would calculate a higher score than if the image ranking received a ranking of 2 and could achieve the look for $10K. The designer onboarding would ask the designer to give approximations of the cost of achieving the presented space within ranges of $1,000 inclusive of their design fee. The results presented would also show “This designer is within 0.5 miles; within 100 miles; in Pennsylvania, etc.” In the background of the algorithm—available internally, it will show that this designer meets 7 out of 10 style adjectives and all three of the design styles indicated by the client user.

In step 450, matching manager 122 retrieves a set of designs corresponding to designers in the initial candidate designer set. Matching manager 122 retrieves the set of designs that meet all of the search criteria from database 124. A set of designs for the spaces of designers in the initial candidate designer set of designers may be retrieved for output and display on application 102. Matching manager 122 may retrieve images of the designs that make up the candidate set from database 124. In one example, a predetermined number of images per identified space(s) are retrieved (such as, up to 250 images total per space) that meet the criteria of location, scope of work and budget for up to three designers. In one embodiment, a mathematical algorithm may be used that determines the correct minimum number of images per space selection that would lead to an “optimal/fair” score rating. So, for example, if a homeowner wants to renovate a space that the “average” homeowner does not have, let's say a theatre room, and within the database of interior designers, there are few professionals that have created that space—for the purposes of this example, let's say two designers have images of theatre spaces that they have created, but perhaps not within the investment range the homeowner has indicated but within the style that the homeowner has selected. The algorithm either say that “there are no results meeting all of your criteria” OR it would show the two images of the theatre room with the note to the homeowner that the images shown do not reflect the budget range indicated and give a percentage increase over their budget range. This would give the homeowner the opportunity to revise their budget to something more realistic for their scope of work or to seek other alternatives i.e., decorate the space rather than renovate. The algorithm would determine a minimum number of results per space that would provide a sufficient sample size in order for the user to make a selection for each space.

In step 460 shown in FIG. 4B, control proceeds to output the retrieved set of designs for the project to the user for review and ranking. For example, matching manager 122 may output the retrieved images for designs to application 102 for review and ranking. The user may then review each image and input ranking information to rank the images for different designs in each space. In one feature, the images are provided to the user for review and ranking, but information identifying a particular designer is yet not made available to a user until after platform 120 performs an electronic introduction. In this way, a user sees only images for ranking and does not see names or any indicators of the interior designer/decorator. This new way of selecting and matching images allows a homeowner to choose images based purely on the interior designers/decorators finished work product and removes bias. This hidden name protocol helps to ensure that initial biases are removed, and that the candidate designer is presented to the homeowner fairly and equally based purely on the quality of their installed work, the location and their ability to produce a finished quality within the homeowners' investment/budget.

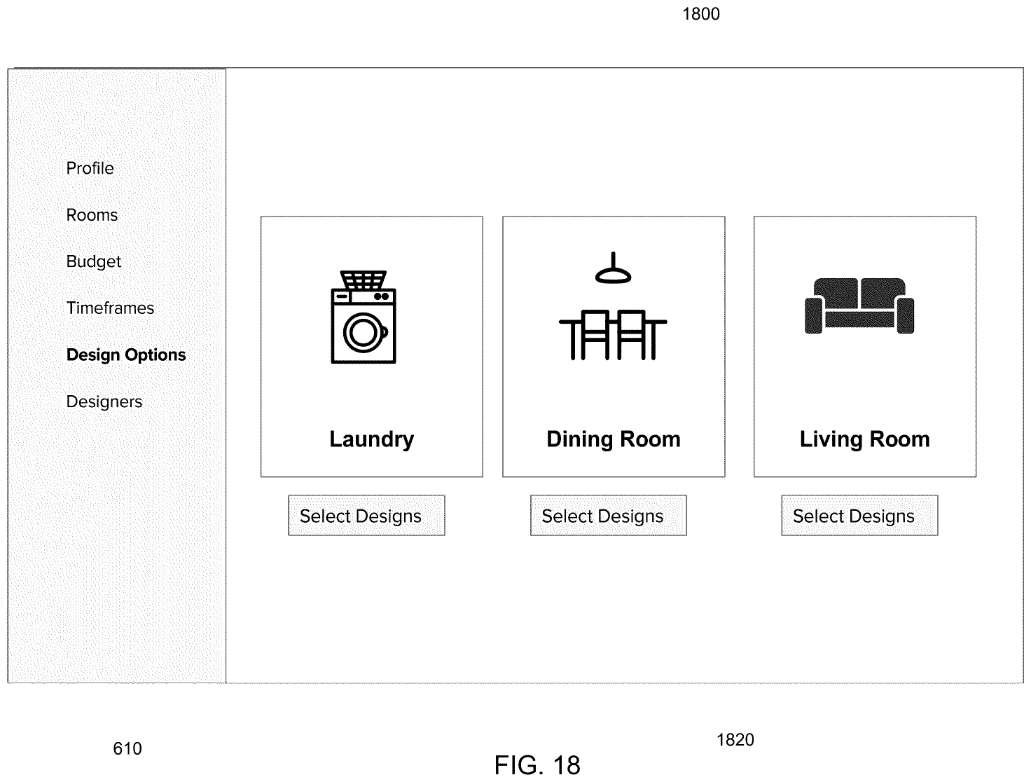

FIGS. 18-21 shows examples of display views for application 102 that may be used to display images and to enable a user to input ranking information. In FIG. 18, display view 1800 has a content area 1820 that shows icons for each of the spaces in the design project. For example, three icons (Laundry, Dining Room and Living Room) are shown in FIG. 18 corresponding to three spaces prioritized in step 420. Selectable buttons (labeled Selected Designs) are placed near the icons to allow a user to select designs for the respective spaces.

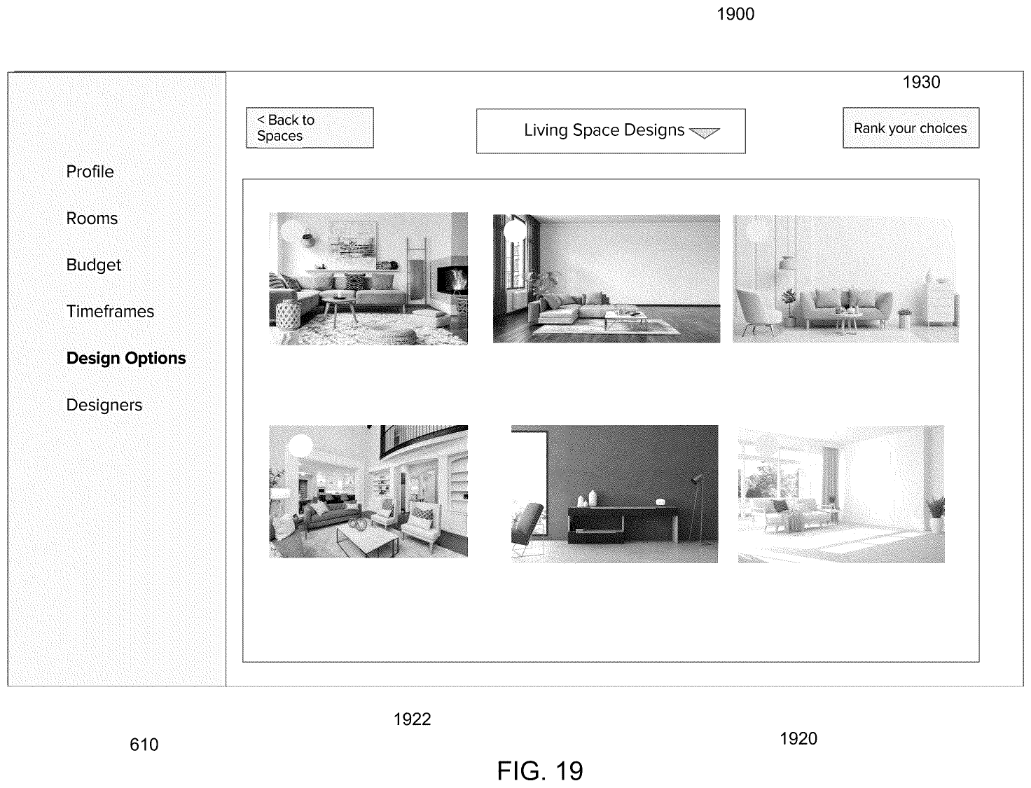

As shown in FIG. 19, when a user selects the button for icon Living Room, another display view 1900 is output on application 102. Display view 1900 has a content area 1920 with a panel 1922 showing multiple images of designs for the living room space. These images correspond to the set of designs for the particular space output in step 460. Images may be placed side-by-side, in a grid pattern, a ribbon or scroll arrangement, or other order of presentation. A rank button 1930 enables a user to select to rank the images. As shown in FIG. navigation buttons or tools may be added in display view 2000 to allow the user to navigate to different images to input ranking information or to go back.

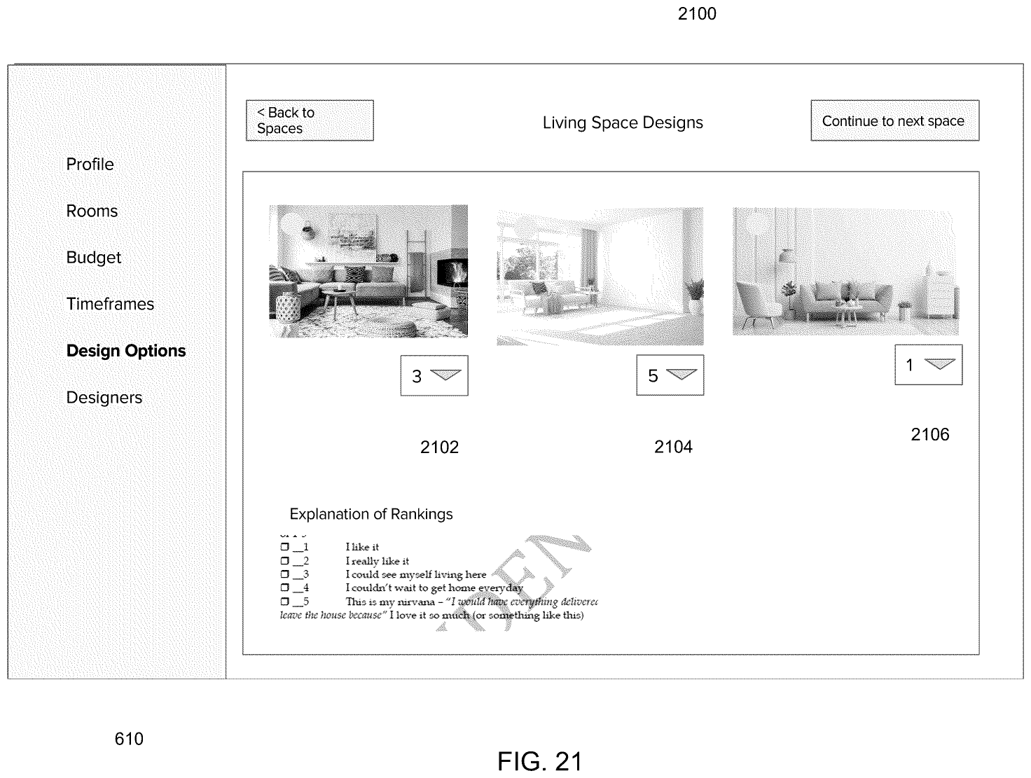

FIG. 21 shows a display view 2100 that may be shown in response to a user selecting a rank button 1930. Display view 2100 includes a pull-down menu (2102, 2104, 2106) next to each image of a design for a living space. The pull-down menu enables a user to select a rank for a design shown in the respective image. In one embodiment, a rank between 1 to 5 can be selected, where 1 indicates the lowest level of like and 5 indicates the highest level of like by the user. As shown in FIG. 21, the same or different ranking information can be selected for each image.

In one embodiment, a homeowner may review and select those images that they like and have an initial strong visceral response to. The homeowner would simply click the images that they like and save for review. All of the selected images are then shown, and the homeowner ranks them on a scale of how much the design style in the image truly resonates with them and how much they want this style in their home. One ranking scale is associated with a numerical value and can follow the scale below from highest (5) to lowest (1):
This is my dream home, i.e., my Nirvana (5)
I love this—I could definitely see myself living here (4)
I like this (3)
Meh (2)
Not so much (1).

Once the ranking information is input in step 460, the ranking information is received for the set of designs (step 470 ). For example, ranking information may be received by application 102, stored on device 101 and sent to platform 120 for receiving by matching manager 122.

In step 480, matching manager 122 calculates a score for each image based on the received ranking information and search criteria (such as, location, style/aesthetic, and budget).

In step 482, matching manager 122 then determines a group of top ranked designers having images that correlate to the highest overall scores. Calculated scores and associated top ranked designers' information may be stored in database 124 (step 490). Information on other designers associated with lower scores may also be stored in database 124 (that is banked) in step 490 so that they can be accessed in case one or more of the initial group of top ranked designers is unavailable or is not chosen by the client, or vice versa, for whatever reason. In one implementation, the client will not receive more than three designer names at any one time and the interior designer/decorator will not compete with more than two other designers/decorators at any one time. A user, such as a homeowner, will only be allowed to receive another selection once one of the other initial three selections is removed or disqualified. In this way, online design matching can be carried out efficiently between parties without overburdening users and keeping the competition between designers' fair and focused. Data transmission and display is performed efficiently without larger amounts of less helpful data and choices being transmitted and displayed.

In one embodiment, matching manager 122 performs a further check to determine whether a user is enrolled as a member of service 110 prior to providing designer contact information or making an electronic introduction. If not, as shown in FIG. 22, a display view 2200 may be represented to the user to invite the user to join service 110 as a full member. Additional information, such as an application form, may also be provided.

In step 492, matching manager 122 then electronic introduces the user to designers corresponding to the top three ranked designs according to their ranking priority. In one embodiment, matching manager 122 only performs the electronic introduction when it receives a further confirmation from the user to proceed. In another embodiment, matching manager 122 only performs the electronic introduction when it receives further confirmations from the user and the ranked designer to proceed. In a further embodiment, matching manager 122 performs the electronic introduction automatically when user and designer profile information has indicated an approval to automatically perform introductions.

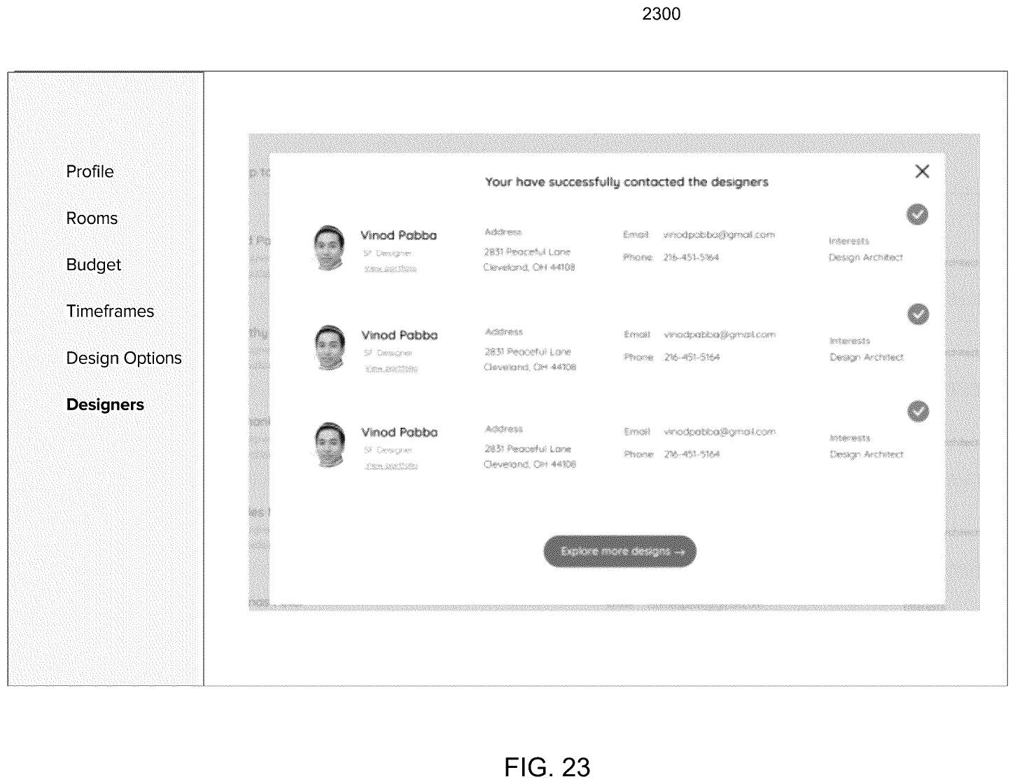

Finally, FIG. 23 shows a display view 2300 that may be displayed by application 102 to a user to show the matching designer contact information. The displayed designer contact information may include a name, address, email address, phone number, website, social media or other contact information. A profile photo or other identifier may also be included. A visual indication (e.g., a green check or a red x mark) can indicate whether a user has successfully been introduced to the particular designer. Additional navigation buttons may be included to allow a user to explore more design options, Or navigate back or close the application. Also, a summary page listing information about each designer may also be sent or output to the user by platform 120.

In making an electronic introduction, information about the user (also called the client information/summary sheet when a user is a member of the service 110) may also be sent or output to the designer by platform 120. For example, FIG. 29 shows a display view 2900 having a summary of client information that may be provided to each designer through application 102 in communication with matching manager 122. In this way, each designer has information about the client and can access it more quickly without a need for the user to resubmit information already provided to platform 120.

### Whole Spaces

In a further feature, platform 120 can also support online design project matching of users to designers for design projects that encompass a whole space. As described with respect to step 410 above, a user may select a button 624 indicating the user wishes to design a whole space (such as an entire home or condo). Steps 420-492 then proceed as described above for individual spaces.

In one embodiment, matching manager 122 may query the user about the type of whole space. For example, as shown in FIG. 16A, a display view 1600 may be output on application 102. Display view 1600 has a display area 1620 with a whole space selection panel 1630 that enables a user to select either a home panel 1632 or a condo/coop panel 1634 similar to description above for the selection of individual spaces. Home panel 1632 further includes one or more user-interface elements, such as, pull-down menus, that enable a user to select or add notes about an existing structure, design style, or other information. Condo panel 1634 includes one or more user-interface elements, such as, pull-down menus, that enable a user to select or add notes about condo or coop, design style, or other information. A user may indicate whether the whole space is for new construction (including full interior design services); full gut renovation; or partial gut renovation (four or more spaces, on two or more floors, for example in a single-family home; two or more spaced on one or more floors for a condo/coop).

As shown in FIG. 16B, control for matching an online design project for a whole space can then proceed to provide a budget/project investment display view 1650. Display view 1650 includes a user-interface element, such as, a checkbox and pull-down menu to allow a user to indicate what a total investment for the project is including a budget range.

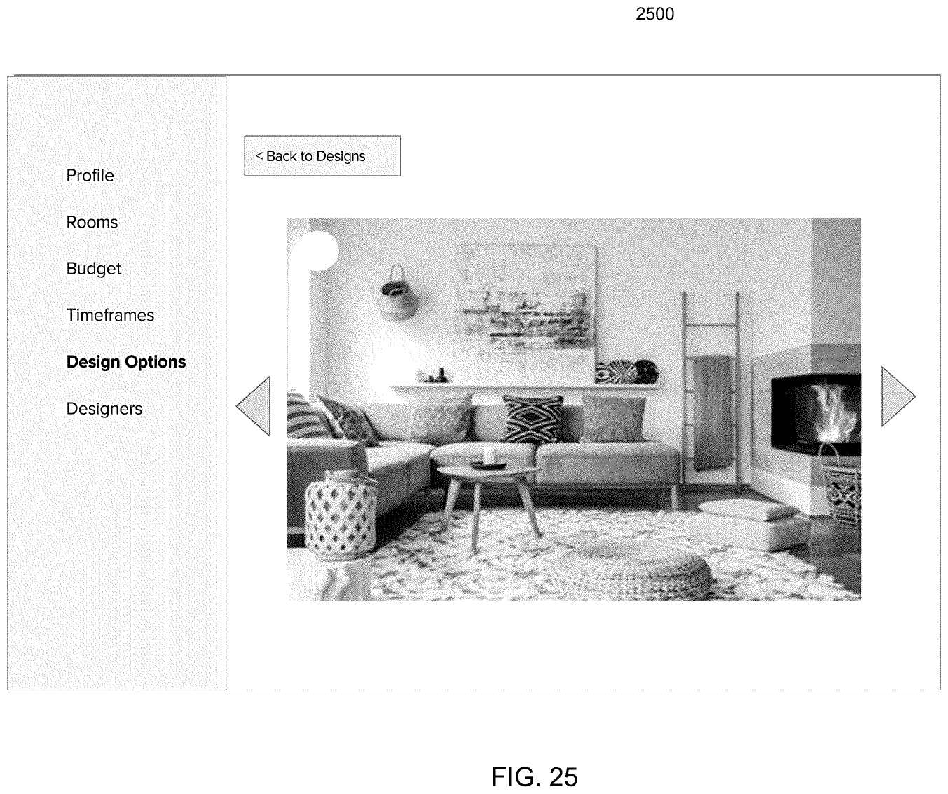

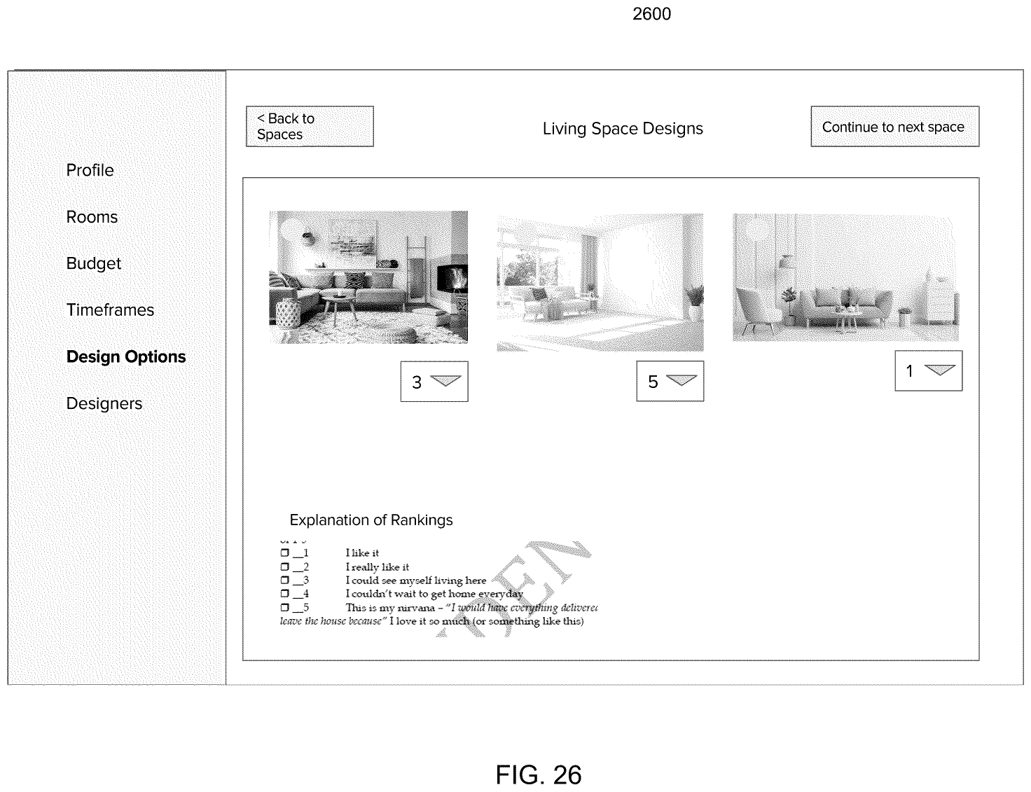

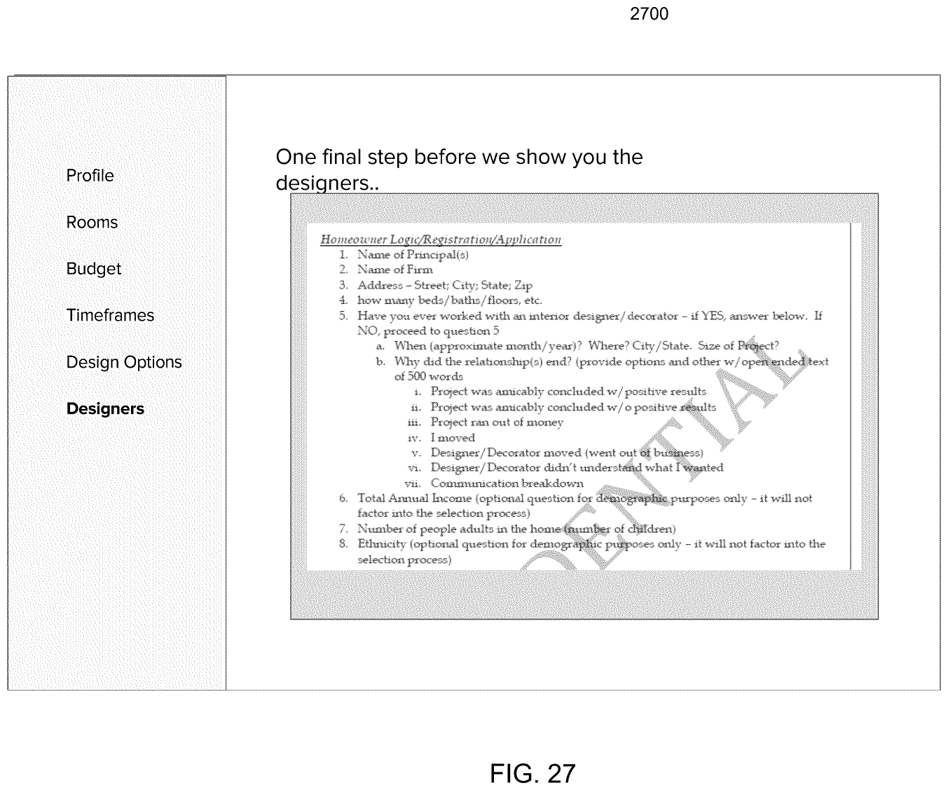

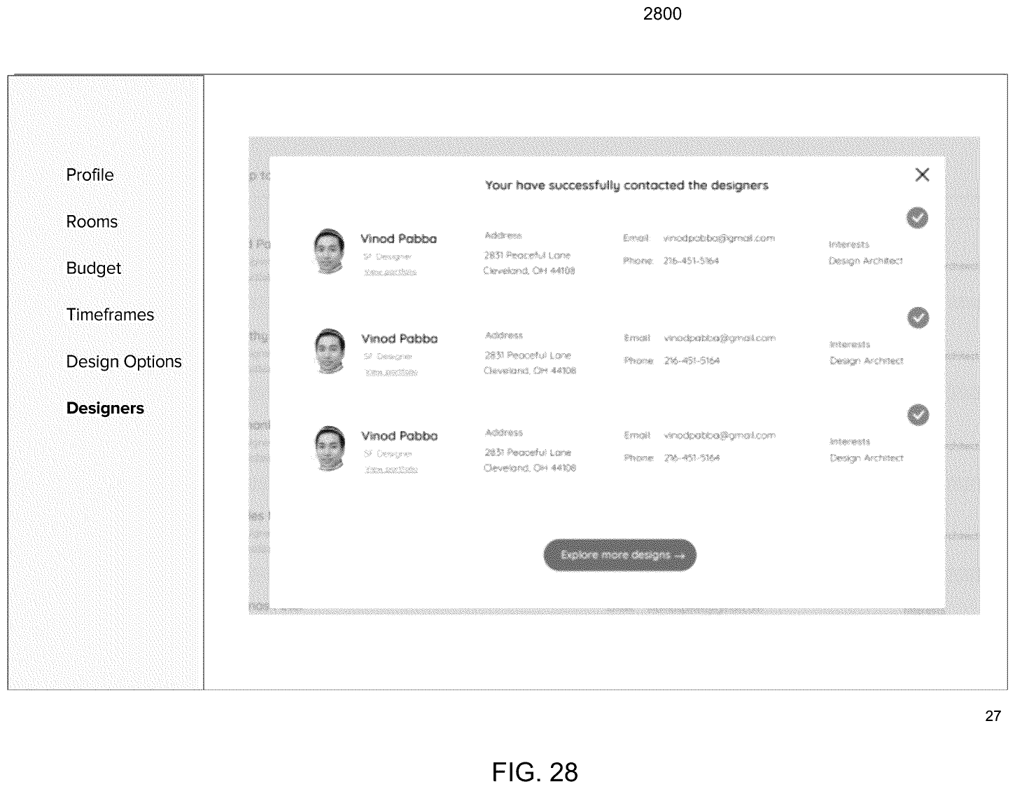

FIGS. 25-28 show example display views 2500-2800 that may be displayed to a user on application 102 in response to a selection to match designers for a whole space project. Display view 2400 shows images for designs for whole spaces and includes a rank button for adding ranking information. Display view 2500 in FIG. 25 shows an example of an image for a design of a living room within a whole space project. Display view 2600 in FIG. 26 shows an example of selected images of designs along with ranking information input by a user for a whole space project. Finally once images for designs are elected and ranked, a display view 2700 in FIG. 27 may be shown to allow further information, such as, an application form, for the whole space design project similar to what was described before with respect to FIG. 22. Also, a display view 2800 as shown in FIG. 28 may be output to provide designer contact information as described form with respect to FIG. 23. In some jurisdictions, if walls are being removed/added then the designer must be a licensed interior designer i.e., NCDIQ certified and licensed by the state/city. It may also be asked of both the client and designer if they have their own crew or if the builder/architect will be provided by the client.

### Further Embodiments

In some examples not intended to be limiting, processing and storage in steps 410-492 may be carried out primarily by matching manager 122 on a server-side in communication with application 102 at a client-side. In this way, processing and data storage can be scaled and carried out more efficiently on a server-side. In other examples, processing and storage in steps 410-492 may be carried out primarily by application 102 on a database or memory in device 101 at a client-side with some communication with matching manager 122. In this way, processing and data storage can be carried out on a client-side on devices having sufficient processing power and data storage, thereby, reducing network traffic and the number of data requests sent between device 101 and platform 120. In still further examples, processing and storage in steps 410-492 may be distributed between matching manager 122 on a server-side and application 102 at a client-side according to a particular application environment as would be apparent to a person skilled in the art given this description.

In further features, system 100 may support report generation and may allow a homeowner and the professional receive a synopsis sheet to capture important details and images from the very beginning, saving time and energy from the onset in the user's search to find a compatible architect or interior designer (A&D) professional to suit their purposes. System 100 (and in particular platform 120) has the added advantage of being a cost-effective marketing tool for the A&D professional, thereby giving the A&D professional another outlet to find new clients, increase their market outreach and build their business, regardless of their size and scope. In certain embodiments it provides the ability for clients to send out their projects over a certain amount for bid and have professionals submit bids for the homeowner to consider.

In certain embodiments, system 100 allows for students and/or those with limited professional experience to participate in the site for a lower annual fee or for free. The projects can be relatively small or limited in scope i.e., one decorated space, below a certain square footage or below a predetermined budget. Those design professionals that are new to the field will be given an introductory rate code that will be unique to them for reduced price for six to 12 months.

In another embodiment, platform 120 may include a communication engine, such as an API (Application Programming Interface) that allows designers can use a Slack service (or similar broad based, closed communication channel for subscribers of the application) to exchange ideas, resources, and other information. This channel can also have subgroups to address location, topics, client management issues, design styles, etc. In a further optional feature, restrictions may be put in place to moderate content and prevent a communication channel from being used to share disparaging remarks about current, previous, or prospective clients/customers.

In certain embodiments, platform 120 may include a communication assistant, such as, is an automated assistant computer “guide”, for example Debbie Designer (or Debbie Dzyner), that is used to answer questions via the Blog articles and will be the “Dear Abby” of the blog site allowing the homeowner to gain insight and an understanding of basic questions — particularly if they have never worked with a designer (or even if they have).

The services of the instant system 100 as described herein allow both of the above needs to be met—of both the trade clientele as well as the consumer. In addition, the site provides a new cost-effective resource that provides exposure to the professional, or supplements their marketing and advertising efforts, is provided. It offers far-reaching marketing impact for a relatively low investment relative to other sites that market to the A&D community as well as design showhouses, magazine advertising and other events that come at a significant financial investment for most designers.

In certain embodiments, the trade professional is able to log on and view how many times someone has clicked/viewed their profile or visited their website or social media page via this application. One purpose of the site for the trade professional is to drive business to them and/or their site, providing them maximum exposure to new clientele that they would not otherwise have.

In another embodiment, the site can vet all trade professionals as part of the application process to confirm basic information i.e., do they have a basic business license in their city/state, are they affiliated with professional organizations, do they have any current or pending legal action, etc. This type of information provides the homeowner with a level of confidence about the professionals that are affiliated with the site. The site may incorporate a “seal of approval/badge” icon that the trade professional that can be placed on their website, social media and other marketing of the trade professional.

In another embodiment, the site can incorporate a rating review system (i.e., stars) of the trade professional allowing comments and areas of improvement for the trade professional.

The company may provide professional photographers and/or stagers to the trade applicants to assist designers with getting their work photographed for inclusion on the site as well as on their website, social media and/or portfolio.

In certain embodiments, sales contract information is provided and includes terms relating to:
1. Interior designers
2. Landscape architects
3. Architects
4. Builders (especially design/builders)
5. Contractors
6. Stagers/interior designers
7. Students (on all levels)

This information is built into an automatically generated initial contract/terms of agreement between the client and designer, as generated by agreement manager 136.

In certain embodiments, a client visiting the website would know specifically which type of trade person they wanted i.e., an interior designer, interior architect, design builder, architect, etc. The user client needs a design build firm that has an interior designer on staff or an interior designer that has access to a design build company. The questions would need to be posed to the client correctly that it could lead them to the same grouping of trade professionals. The website can give the client of going directly to a trade category of their choice or Debbie Dzyner can guide them in their search by asking them a series of questions

### Example Implementations

Aspects of the embodiments for exemplary system 100 including platform 120 (and matching manager 122) and database 124 thereof may be implemented electronically using hardware, software modules, firmware, tangible computer readable or computer usable storage media having instructions stored thereon, or a combination thereof and may be implemented in one or more computer systems or other processing systems. In embodiments, platform 120 including matching manager 122 may be implemented electronically using hardware, software modules, firmware, tangible computer readable or computer usable storage media having instructions stored thereon, or a combination thereof and may be implemented in one or more computer systems or other processing systems at the same location or different locations.

One exemplary pseudo code for the above system is as follows:

```
// Step 1: User Information Entry
    display “Welcome to the Design Project Matching Platform!”
    display “Please enter your name and password:”
    input name, password
    display “Enter the name of your project:”
    input projectName
// Step 2: Location and Search Type
    display “Please enter your location (ZIP code):”
    input zipCode
    display “Do you want the search to be local, regional, or national?”
    input searchType
// Step 3: Project Scope
    display “What type of home is the project located in?”
    display “Options: Single Family Home (SFH), Condo, Coop, Townhome”
    input homeType
    display “Do you want a designer/decorator or a designer/renovator?”
    display “Options: Design/Decorate, Design/Renovate, Both (Combination)”
    input designType
// Step 4: Project Timeframe
    display “Do you have a specific start or end date for the project?”
    display “Type ‘skip’ if you are open to a start date.”
    input startDate, endDate
// Step 5: Scope of Work
    display “Identify the rooms to be renovated:”
    display “Options: Living Room, Kitchen, Bathroom, Bedroom, etc.”
    input selectedRooms[ ]
// Step 6: Number of Spaces to Design/Renovate
    display “For each room, enter the number of spaces to design/decorate or
    design/renovate:”
    input spacesToDesign[ ]
    if designType is “Both”:
      display “Choose design direction for each space:”
      display “Options: Decoration, Renovation”
      input designDirection[ ]
    // Step 7: Design Aesthetic
    display “Determine the overall style direction (Beta version):”
    input designStyle
// Step 8: Match with Designers
// Algorithm will match the user with up to three designers based on user information
Sure! Here's a pseudocode for Step 8: Match with Designers
// Step 8: Match with Designers
          // Define a data structure for designers
          struct Designer {
            string name;
            string specialization;
            // Add other relevant information about designers as needed
          }
          // Define a function to match the user with designers based on user information
          function matchWithDesigners(name, location, designType, selectedRooms[ ],
          spacesToDesign[ ], designDirection[ ], designStyle):
            // Create an empty list to store matched designers
            List<Designer> matchedDesigners;
            // Retrieve designers from the database or a pool of available designers
            List<Designer> allDesigners = getAvailableDesigners( );
// Loop through each designer to check for matches
for designer in allDesigners:
  // Check if the designer's specialization matches the user's designType
  if designer.specialization is equal to designType:
    // Check if the designer's location is compatible with the user's location
    if isLocationCompatible(designer.location, location, searchType):
      // Check if the designer is available for the project timeframe (if provided)
      if isDesignerAvailable(designer, startDate, endDate):
        // Check if the designer's style direction matches the user's designStyle
        if designer.styleDirection is equal to designStyle:
          // Check if the designer can handle the selected rooms and spaces
          if isDesignerCapable(designer, selectedRooms[ ], spacesToDesign[ ],
designDirection[ ]):
            // Add the designer to the list of matched designers
            matchedDesigners.add(designer);
  // Return the list of matched designers
// Step 9: Meeting with Designers
    // User can provide more detailed design aesthetic and discuss the project scope with
designers
// Step 10: Further Configuring Scope of Work
    // Same as Step 5 and Step 6, but now the user can specify design aesthetic for each space
// End of the process
display “Thank you for providing the information. We will match you with suitable designers.”
```

In one embodiment a hash data structure is used for Step 8. Step 8: Match with Designers, the most optimal data structure for efficiently matching designers based on user information would be a hash table (hash map). One reason for choosing a hash table is its fast average-case time complexity for insertion, deletion, and lookup operations, which are the fundamental operations required for matching designers with users. In a hash table, designers can be stored with their unique identifier (e.g., designer ID) as the key, and the designer's information (e.g., name, specialization, location, style direction) as the value. Hashing allows for constant-time (O(1)) average-case complexity for insertion, deletion, and lookup operations, making it highly efficient for building and querying the dataset of designers. Pseudocode for using a hash table to store designers is as follows:

```
// Define a hash table to store designers
HashTable<string, Designer> designersTable;
// Assuming the data is retrieved and added to the hash table before the matching process
// Function to match the user with designers based on user information using the hash table
function matchWithDesigners(name, location, designType, selectedRooms[ ], spacesToDesign[ ],
designDirection[], designStyle):
  // Create an empty list to store matched designers
  List<Designer> matchedDesigners;
  // Get the list of designers with the matching designType from the hash table
  List<Designer> designersWithMatchingType = designersTable.lookup(designType);
  // Loop through each designer to check for matches
  for designer in designersWithMatchingType:
    // Check if the designer's location is compatible with the user's location
    if isLocationCompatible(designer.location, location, searchType):
      // Check if the designer is available for the project timeframe (if provided)
      if isDesignerAvailable(designer, startDate, endDate):
        // Check if the designer's style direction matches the user's designStyle (Beta version)
        if designer.styleDirection is equal to designStyle:
          // Check if the designer can handle the selected rooms and spaces
          if isDesignerCapable(designer, selectedRooms[ ], spacesToDesign[ ],
designDirection[ ]):
            // Add the designer to the list of matched designers
            matchedDesigners.add(designer);
  // Return the list of matched designers
  return matchedDesigners;
```

Using a hash table for this scenario ensures that the matching process is efficient and scalable, especially when dealing with a large number of designers and user requests. However, it's essential to ensure that the hash function used for hashing the designer information is well-distributed to avoid excessive collisions and maintain the average-case complexity.
For a cloud-based system that aims to specify architectural design projects for homes with different rooms, a suitable data structure to consider is a graph-based representation. Specifically, an attributed graph can be utilized, where each node in the graph represents a room, and edges between nodes represent relationships or connections between rooms. The attributes associated with each node can hold specific information about the room, such as its dimensions, purpose, style, design features, and any other relevant details.
An attributed graph offers several advantages for this scenario:
Flexible Representation: The graph structure allows for a flexible representation of the home's architecture, making it easy to capture complex relationships between rooms. For example, a living room may have connections to both the kitchen and the dining area, while a bathroom might have a connection to a master bedroom.
Efficient Querying: By using a graph-based data structure, the cloud-based system can perform efficient graph traversal algorithms to find relevant matches for architectural design projects. For instance, the system can find rooms that are directly or indirectly connected to a given room, enabling the selection of rooms that are part of the same project scope.
Scalability: As the number of rooms and architectural projects grows, the graph-based data structure remains scalable and can easily accommodate new rooms or projects without a significant increase in data access time.
Graph Analytics: The system can utilize graph analytics techniques to identify design patterns, detect trends, and generate design recommendations based on the relationships between rooms. For example, the system could suggest popular combinations of rooms for specific design styles.
Integration with Cloud Databases: Graph databases are well-suited for handling and managing complex relationships between data. By integrating the attributed graph data structure with a cloud database, the system can efficiently store and retrieve information about architectural projects and related rooms.
   Example Pseudocode for Creating the Attributed Graph is as follow:

```
class Room:
  string roomType;
  string roomPurpose;
  string roomStyle;
  // Add other attributes specific to each room
class AttributedGraph:
  Map<string, Room> rooms;
  Map<string, List<string>> connections;
  // Function to add a room to the graph
  function addRoom(roomId, roomType, roomPurpose, roomStyle, ...):
    Room room = new Room(roomType, roomPurpose, roomStyle, ...);
    rooms.insert(roomId, room);
  // Function to add a connection between two rooms
  function addConnection(roomId1, roomId2):
    if connections.contains(roomId1):
      connections[roomId1].add(roomId2);
    else:
      List<string> connectedRooms = new List<string>( );
      connectedRooms.add(roomId2);
      connections.insert(roomId1, connectedRooms);
    // Since the graph is undirected, add a reverse connection as well
    if connections.contains(roomId2):
      connections[roomId2].add(roomId1);
    else:
      List<string> connectedRooms = new List<string>( );
      connectedRooms.add(roomId1);
      connections.insert(roomId2, connectedRooms);
```

The above pseudocode provides a basic structure for building the attributed graph to represent the architectural design project. It allows for adding rooms to the graph and specifying connections between rooms. By using this data structure, the cloud-based system can efficiently match architectural design projects by navigating the graph to find relevant combinations of rooms based on their attributes and relationships. This graph-based representation enables the system to quickly identify sets of rooms that work well together in a given design context, leading to improved computer matching performance.
For a cloud-based system to efficiently match designers with clients who have architectural design projects for homes with different rooms, a suitable data structure to consider is a k-d tree.
A k-d tree (short for k-dimensional tree) is a space-partitioning data structure that efficiently organizes points in a k-dimensional space. In this context, each designer and client project can be represented as a point in a multi-dimensional space, where each dimension corresponds to a specific attribute or preference relevant to the architectural design project. For example, dimensions could represent the style, experience, location, project size, and other relevant factors.
The k-d tree offers several advantages for one embodiment:
Efficient Spatial Partitioning: The k-d tree divides the multidimensional space into smaller regions, which allows for faster searching and matching. The tree's structure enables a divide-and-conquer approach to find the most suitable designers for a given client project efficiently.
Fast Nearest Neighbor Search: One of the main advantages of k-d trees is their ability to perform fast nearest neighbor searches. This is crucial for quickly identifying designers who are closest to a client's preferences in the multi-dimensional space.
Balanced Tree Structure: A well-balanced k-d tree ensures that the search time remains relatively constant, even as the number of designers and clients increases. This balanced structure leads to improved performance and speed for matching.
Scalability: As more designers and client projects are added to the system, the k-d tree remains scalable and can efficiently handle large datasets.
Support for High-Dimensional Data: K-d trees perform well even with high-dimensional data, making them suitable for representing various attributes and preferences of designers and clients.

### Example Pseudocode for Building the k-d Tree:

```
class Designer:
  string name;
  string style;
  string location;
  // Add other attributes relevant to the designer
class ClientProject:
  string projectName;
  string desiredStyle;
  string location;
  // Add other attributes relevant to the client project
class KDNode:
  Designer designer; // or ClientProject clientProject
  KDNode left;
  KDNode right;
class KDTree:
  KDNode root;
  // Function to add a designer or client project to the k-d tree
  function addNode(node, depth):
    if root is null:
      root = node;
    else:
      axis = depth % k; // k is the number of dimensions
      if node.position[axis] < root.position[axis]:
        if root.left is null:
          root.left = node;
        else:
          addNode(node, depth + 1);
      else:
        if root.right is null:
          root.right = node;
        else:
          addNode(node, depth + 1);
// Example usage to build the k-d tree with designers and client projects
KDTree kdTree = new KDTree( );
for designer in allDesigners:
  KDNode node = new KDNode(designer);
  kdTree.addNode(node, 0);
for clientProject in allClientProjects:
  KDNode node = new KDNode(clientProject);
  kdTree.addNode(node, 0);
```

The above pseudocode provides a basic structure for building the k-d tree to represent designers and client projects. The k-d tree allows for fast searching of nearest neighbors, making it efficient for matching designers with clients based on their preferences and project attributes. This data structure significantly improves the speed and performance of the matching process in a cloud-based system, enabling quick and accurate identification of designers who are the best fit for a particular architectural design project.

Example computing devices (such as remote computing devices 101) that may be used by users include, but are not limited to, a mobile computing device (such as a smartphone or tablet computer), a desktop computer, laptop computer, set-top box, smart television, smart display screen, kiosk, or other type of computing device having at least one processor and computer-readable memory. In addition to at least one processor and memory, such a computing device may include software, firmware, hardware, or a combination thereof. Software may include one or more applications, a browser, and an operating system. Hardware can include, but is not limited to, a processor, memory, display, or other input/output device.

Embodiments may be directed to computer products comprising software stored on any computer usable medium such as memory. Such software, when executed in one or more data processing device, causes a data processing device(s) to operate as described herein.

In an embodiment, platform 120 including matching manager 122 and database 124 may be implemented in an architecture distributed over one or more networks 103, such as, for example, a cloud computing architecture. Cloud computing includes but is not limited to distributed network architectures for providing, for example, software as a service (SaaS), infrastructure as a service (IaaS), platform as a service (PaaS), network as a service (NaaS), data as a service (DaaS), database as a service (DBaaS), backend as a service (BaaS), test environment as a service (TEaaS), application programming interface as a service (APIaaS), or an integration platform as a service (IPaaS).

Storage database 124 for example may be a database platform running database management software available from an organization such as a commercial vendor or open-source community.

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware. Furthermore, portions of the embodiments may be a computer program product on a computer-usable storage medium having computer readable program code on the medium. Any non-transitory, tangible storage media possessing structure may be utilized including, but not limited to, static and dynamic storage devices, hard disks, optical storage devices, and magnetic storage devices, but excludes any medium that is not eligible for patent protection under 35 U.S.C. § 101 (such as a propagating electrical or electromagnetic signal per se). As an example and not by way of limitation, a computer-readable storage media may include a semiconductor-based circuit or device or other integrated circuit (IC) (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, where appropriate.

Certain embodiments have also been described herein with reference to block illustrations of methods, systems, and computer program products. It will be understood that blocks of the illustrations, and combinations of blocks in the illustrations, can be implemented by computer-executable, or machine-readable, instructions. These computer-executable instructions may be provided to one or more processors of a general-purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

In the description of example embodiments that follows, references to “one embodiment”, “an embodiment”, “an example embodiment”, “certain embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. The term “exemplary” when used herein means “serving as an example, instance or illustration.” Any embodiment described herein as “exemplary” is not necessarily to be construed as preferred or advantageous over other embodiments.

In the interest of clarity, not all of the routine features of the implementations described herein are shown and described. It will be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming but would nevertheless be a routine undertaking of engineering for those of ordinary skill in the art having the benefit of this disclosure.

In accordance with this disclosure, the components, process steps, and/or data structures described herein may be implemented using various types of operating systems, computing platforms, computer programs, and/or general-purpose machines. Devices of a less general-purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card, paper tape and the like) and other types of program memory.

Herein, reference to a computer-readable or machine-readable storage medium encompasses one or more non-transitory, tangible storage media possessing structure. As an example and not by way of limitation, a computer-readable storage medium may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. § 101. Herein, reference to a computer-readable storage medium excludes transitory forms of signal transmission (such as a propagating electrical or electromagnetic signal per se) to the extent that they are not eligible for patent protection under 35 U.S.C. § 101. A computer-readable non-transitory storage medium may be volatile, nonvolatile, or a combination of volatile and non-volatile, where appropriate.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof. Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection and is not limited to either unless expressly referenced as such.

While embodiments and applications have been shown and described, it would be apparent to those skilled in the art having the benefit of this disclosure that many more modifications than mentioned above are possible without departing from the inventive concepts disclosed herein. The invention, therefore, is not to be restricted based on the foregoing description. This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A design matching system comprising:
an application operable on a computing device accessed by a user, the application configured to present a user interface for an entry of user information including one or more of location, style, scope of work or budget for each work item as a group and wherein data for a plurality of work items are stacked in one or more layers and the application filters each stack layer data with location, style, scope of work or budget to locate a match search result for each respective stack layer; and
a matching manager implemented on one or more processors and coupled to the application over a data network,
wherein the matching manager is configured to match the user and one or more professionals based on the user information entered by the user and matching one or more professionals for each stack layer.

2. The system of claim 1, wherein the matching manager is further configured to:
receive initial search criteria for an interior design project;
receive information on a scope of work configured by the user for the interior design project; and
obtain input on at least one desired design style and budget for the configured scope of work.

3. The system of claim 2, wherein the matching manager is further configured to filter available designer information according to the initial search criteria, scope of work, desired design style and budget.

4. The system of claim 2, wherein to filter the available designer information, the matching manager is further configured to:
output a set of designs for the user to review and rank;
receive ranking information for the set of designs;
calculate a score for each image based on the ranking information and search criteria;
determine user designer identification for a top set of ranked designs; and
store scores and ranking information of designers in computer-readable memory.

5. The system of claim 4, wherein the matching manager is configured to electronically introduce the user to the designers corresponding to the determined user designer identification for the top set of ranked designs.

6. The system of claim 1, wherein the scope of work comprises spaces to be designed.

7. The system of claim 1, wherein the matching manager presents multiple sample images to the user for selection by the user.

8. The system of claim 1, wherein the user indicates the property location of the space(s) to be designed and selects whether a space is to be design/decorated, designed/renovated, or both.

9. A computer-implemented designer matching method comprising:
presenting a user interface for entry of user information including one or more of location, style, scope of work and budget; and
using a matching manager to match between the user and one or more professionals based on the user information entered by the user.

10. A computer-implemented designer matching method carried out on a platform coupled over a data network to an application on a remote computing device accessed by a user through a user-interface, the method comprising the steps of:
receiving initial search criteria for an interior design project;
enabling a user to interactively configure a scope of work for spaces for the interior design project;
stacking data from one or more criteria sets including one or more of location, style, scope of work or budget; and
obtaining input on at least one desired design style and budget for the configured scope of work and matching the user based on the stacked data based on stacking sequence.

11. The method of claim 10, further comprising filtering available designer information according to the initial search criteria, scope of work, desired design style and budget.

12. The method of claim 11, wherein the filtering includes:
outputting a set of designs for the user to review and rank;
receiving ranking information for the set of designs;
calculating a score for each image based on the ranking information and search criteria;
determining user designer identification for a top set of ranked designs; and
storing scores and ranking information of designers in computer-readable memory.

13. The method of claim 12, further comprising electronically introducing the user to the designers corresponding to the determined user designer identification for the top set of ranked designs.

14. The method of claim 10, wherein the scope of work comprises spaces to be designed.

15. The method of claim 10, further comprising presenting multiple sample images to the user for selection by the user.

16. The method of claim 10, further comprising enabling the user to indicate the property location of the space(s) to be designed and select whether a space is to be design/decorated, design/renovated, or both.

17. The method of claim 16, wherein the user is a client.

18. The method of claim 1, wherein the professionals include interior designers, architects, landscape architects, design builders, kitchen and bath designers.

19. The method of claim 1, wherein the user specifies a new stack for each of the professionals.

18. A method of matching one or more clients to one or more service providers, comprising:
presenting a user interface for an entry of user information including one or more of location, style, scope of work or budget, each being a layer of a stack;
filtering the data in the stack to provide a match search result with one or more professionals; and
matching one of the clients to one or more service providers based on the user information entered by the user.
